(19) United States
(12) Patent Application Publication
(10) Pub. No.: US 2026/0064733 A1
(43) Pub. Date: Mar. 5, 2026

(54) INFORMATION PROCESSING APPARATUS, INTERMEDIARY METHOD, AND RECORDING MEDIUM

(71) Applicant: NEC CORPORATION, Tokyo (JP)

(72) Inventor: Masashi KAWASHIMA, Tokyo (JP)

(73) Assignee: NEC CORPORATION, Tokyo (JP)

(21) Appl. No.: 18/818,773

(22) Filed: Aug. 29, 2024

(30) Foreign Application Priority Data
Sep. 6, 2023 (JP) 2023-144683

(51) Int. Cl. G06F 16/332; G06F 16/35

(52) U.S. Cl. CPC G06F 16/3329; G06F 16/353

(57) ABSTRACT

Easily conducting a survey in which answers to a predetermined question are collected is made possible. An information processing apparatus includes: an accepting section for accepting a request for a survey in which answers to a predetermined question are collected; and a negotiating section for conducting, with a predetermined negotiating partner, negotiations for causing a vicariously answering language model to generate an answer to the predetermined question, the vicariously answering language model having been trained by machine learning so as to be capable of generating, as a surrogate for a predetermined user, an answer to an inputted question. This information processing apparatus makes it possible to optimize respondents of a question.

### CROSS REFERENCE TO RELATED APPLICATIONS

This application is based upon and claims the benefit of priority from Japanese Patent Application No. 2023-144683 filed on Sep. 6, 2023, the disclosure of which is incorporated herein in its entirety by reference.

### TECHNICAL FIELD

The present disclosure relates to an information processing apparatus, an intermediary method, and a recording medium.

### BACKGROUND ART

Questionnaire surveys are still widely conducted today. In addition, the development of techniques concerning such surveys are underway. For example, Patent Literature 1 below discloses a questionnaire survey system in which questionnaire survey items are selectively delivered to mobile communications terminals which meet the purpose of the survey, questionnaire answers are collected in exchange for discounting a communication charge, and a client who is the requester of the survey is provided with the collected questionnaire answers.

### CITATION LIST

### Patent Literature

### [Patent Literature 1]

Japanese Patent Application Publication Tokukai No. 2001-312590

### SUMMARY OF INVENTION

### Technical Problem

However, the questionnaire survey system disclosed in Patent Literature 1 is susceptible of improvement in terms of the facilitation of surveys. For example, in order to conduct a questionnaire survey via the questionnaire survey system disclosed in Patent Literature 1, it is necessary to acquire respondents who answer a questionnaire before conducting the questionnaire survey, and acquiring the respondents requires time and cost which are not negligible. Further, the respondents would not be willing to take time to answer a questionnaire.

The present disclosure has been made in view of the above problems, and an example object thereof is to provide a technique which makes it possible to easily conduct a survey in which answers to a predetermined question are collected.

### Solution to Problem

An information processing apparatus in accordance with an example e aspect of the present disclosure includes at least one processor, and the at least one processor carries out: an accepting process of accepting a request for a survey in which answers to a predetermined question are collected; and a negotiating process of conducting, with a predetermined negotiating partner, negotiations for causing a vicariously answering language model to generate an answer to the predetermined question, the vicariously answering language model having been trained by machine learning so as to be capable of generating, as a surrogate for a predetermined user, an answer to an inputted question.

An intermediary method in accordance with an example aspect of the present disclosure includes: at least one processor accepting a request for a survey in which answers to a predetermined question are collected; and the at least one processor conducting, with a predetermined negotiating partner, negotiations for causing a vicariously answering language model to generate an answer to the predetermined question, the vicariously answering language model having been trained by machine learning so as to be capable of generating, as a surrogate for a predetermined user, an answer to an inputted question.

A non-transitory recording medium in accordance with an example aspect of the present disclosure has recorded thereon an intermediary program for causing a computer to function as: an accepting means for accepting a request for a survey in which answers to a predetermined question are collected; and a negotiating means for conducting, with a predetermined negotiating partner, negotiations for causing a vicariously answering language model to generate an answer to the predetermined question, the vicariously answering language model having been trained by machine learning so as to be capable of generating, as a surrogate for a predetermined user, an answer to an inputted question.

### Advantageous Effects of Invention

An example aspect of the present disclosure provides an example advantage of enabling a technique to be provided, the technique making it possible to easily conduct a survey in which answers to a predetermined question are collected.

### BRIEF DESCRIPTION OF DRAWINGS

FIG. 1 is a block diagram illustrating a configuration of an information processing apparatus in accordance with the present disclosure.

FIG. 2 is a flowchart illustrating a flow of an adjustment method and a response method in accordance with the present disclosure.

FIG. 3 is a block diagram illustrating a configuration of another information processing apparatus in accordance with the present disclosure.

FIG. 4 is a flowchart illustrating a flow of an intermediary method in accordance with the present disclosure.

FIG. 5 is a block diagram illustrating a configuration of still another information processing apparatus in accordance with the present disclosure.

FIG. 6 is a representation of an example operation of the information processing apparatus illustrated in FIG. 5.

FIG. 7 is a flowchart illustrating a flow of processes in which the information processing apparatus illustrated in FIG. 5 adjusts a language model.

FIG. 8 is a flowchart illustrating a flow of processes carried out by the information processing apparatus illustrated in FIG. 5 in generating and presenting an answer to a query.

FIG. 9 is a representation of a configuration of a survey system in accordance with the present disclosure.

FIG. 10 is a block diagram illustrating a configuration of still another information processing apparatus in accordance with the present disclosure.

FIG. 11 is a block diagram illustrating a configuration of yet still another information processing apparatus in accordance with the present disclosure.

FIG. 12 is a flowchart illustrating a flow of processes in the survey system illustrated in FIG. 9.

FIG. 13 is a diagram illustrating a flow of question answering conducted between information processing apparatuses in the survey system illustrated in FIG. 9.

FIG. 14 is a flowchart illustrating a flow of example processes carried out by the information processing apparatus illustrated in FIG. 10.

FIG. 15 is a flowchart illustrating a flow of example processes carried out by the information processing apparatus illustrated in FIG. 11.

FIG. 16 is a flowchart illustrating example processes in which the information processing apparatus illustrated in FIG. 11 accepts an additional question.

FIG. 17 is a flowchart illustrating example processes in which the information processing apparatus illustrated in FIG. 11 evaluates an answer and renegotiates.

FIG. 18 is a block diagram illustrating a configuration of a computer which functions as the information processing apparatuses in accordance with the present disclosure.

### EXAMPLE EMBODIMENTS

The following description will discuss example embodiments of the present invention. The present invention is not limited to the example embodiments below, but may be altered in various ways by a skilled person within the scope of the claims. For example, any example embodiment derived by appropriately combining technical means disclosed in the example embodiments below is also within the scope of the present invention. For example, any example embodiment derived by appropriately omitting one or more of the technical means adopted in the example embodiments below is also within the scope of the present invention. An example advantage mentioned in each of the example embodiments below is an example of an advantage that is expected in that example embodiment, and is not intended to define an extension of the present invention. That is, any embodiment that does not provide the example advantage mentioned in each of the example embodiments below can also be within the scope of the present invention.

### First Example Embodiment

The following description will discuss a first example embodiment, which is an example embodiment of the present invention, in detail with reference to the drawings. The present example embodiment is basic to example embodiments described later. It should be noted that the applicable scope of each technical means adopted in the present example embodiment is not limited to the present example embodiment. That is, each technical means adopted in the present example embodiment can be adopted in another example embodiment included in the present disclosure, to the extent of constituting no specific technical obstacle. Further, each technical means illustrated in the drawings which are referred to for describing the present example embodiment can be adopted in another example embodiment included in the present disclosure, to the extent of constituting no specific technical obstacle.

### (Configuration of Information Processing Apparatus 1)

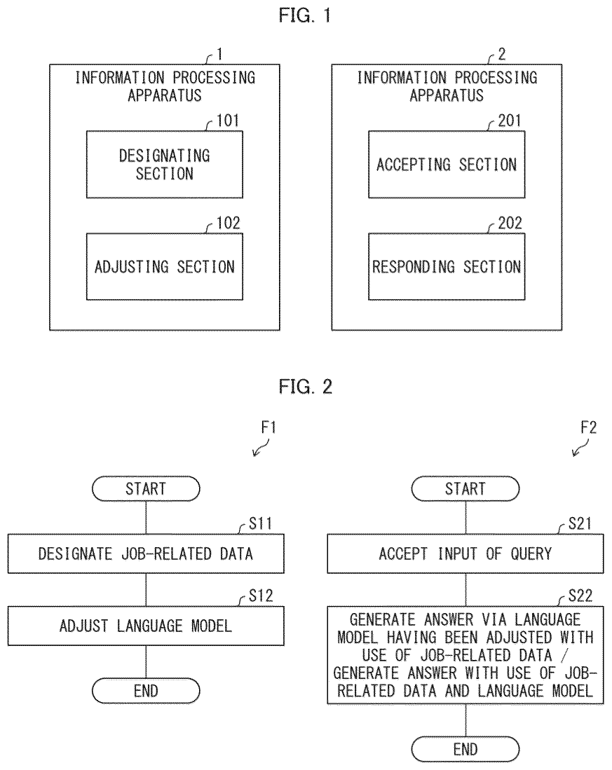

The configuration of an information processing apparatus 1 will be described below with reference to FIG. 1. FIG. 1 is a block diagram illustrating the configurations of the information processing apparatuses 1 and 2. The information processing apparatus 1 includes a designating section 101 and an adjusting section 102, as illustrated in FIG. 1.

The designating section 101 designates data related to the job of a predetermined user as job-related data. The predetermined user is a target user in the adjustment of a language model. What user is taken as the predetermined user is not particularly limited. Further, the “job” means work to be done daily and continuously regarding business or trade. What work is to be taken as the “job” is arbitrarily defined.

The job-related data only needs to be data related to the job of the predetermined user. As an example, the job-related data can be a daily or monthly report which the details of the job of the predetermined user are described, a document professionally prepared by the predetermined user, a mail or message sent or received by the predetermined user during the course of their job, an questionnaire answered by the predetermined user regarding their job, or the like. As another example, in addition to such documents written by the predetermined user during the course of their job, various kinds of data regarding a company to which the predetermined user belongs or a department to which the predetermined user belongs may be taken as the job-related data. To take a specific example, a document describing the company and the department, a document prepared in the company or the department, or the like may be taken as the job-related data. Note that the job-related data is not limited to a document (text), but may be data such as a graph, a chart, a table, sound, or an image. The job-related data in a format other than a textual form can be used after being converted into text with use of, for example, a known conversion-to-text technique.

The adjusting section 102 adjusts, with use of the job-related data, a language model having been trained by machine learning so as to output an answer to a query, such that the language model suits the predetermined user. The “language model” is a model having learned, by machine learning, arrangements of components (such as words) in a sentence and arrangements of sentences in text, and has been trained by machine learning so as to output an answer to a query, as described above.

The “query” means an answer generation order or instruction issued to a language model. The “query” in the following description can therefore be replaced with a “generation order” or “generation instruction”. Further, the form of the query to be inputted is not particularly limited. For example, the query to be inputted may be in a textual form, may be in another form such as an audio form, or may be a query which contains pieces of data in different forms, such as a combination of text and an image. Similarly, the form of an outputted answer to a query is not particularly limited.

A method for adjusting the language model with use of the job-related data is not particularly limited provided that the method enables the language model which suits the predetermined user to be generated. As an example, the adjusting section 102 may retrain the language model use with of the job-related data designated by the designating section 101. Specifically, the adjusting section 102 takes text contained in the job-related data as training data, and carries out the retraining so as to make it possible to infer a part of the text from another part of the text. Assume, for example, that the job-related data contains text reading “the goal for the first half year of the sales department is to improve business performance by 10%”. In this case, the adjusting section 102 uses this text to retrain the language model, such that the retrained language model outputs the answer “improve business performance by 10%” to the query “the goal for the first half year of the sales department”.

As another example, the adjusting section 102 may retrain the language model with use of training data in which text contained in the job-related data designated by the designating section 101 is associated with ground truth data. Assume, for example, that the job-related data contains text reading “the work process of the personnel department”. In this case, the adjusting section 102 uses training data in which this text is associated with text describing the work process of the personnel department, which is the ground truth data, to retrain the language model. Note that a process of associating a ground truth data may be carried out by the information processing apparatus 1, or may be carried out by another apparatus. Further, the training data in which the ground truth data is manually associated may be inputted to the information processing apparatus 1. Alternatively, the adjusting section 102 may generate a plurality of answers to the same query via the language model, and use, as the training data, the results of user's selection of favorite answers from among the plurality of answers.

By registering, as data to be referred to in generating an answer via a language model, the job-related data concerning the predetermined user, the adjusting section 102 may adjust the language model such that the language model suits the predetermined user. With this adjustment, it is possible to generate an answer fit for the predetermined user, by, in generating an answer to a query via the language model, referring to job-related data concerning the predetermined user and using the job-related data which is related to the query, to rewrite the query. Note that the job-related data which is related to a query can be detected by, for example, searching the job-related data with a character string extracted from the query. Assume, for example, that a query “please describe the precautions to be taken in the current job position” is inputted. In this case, by searching the job-related data for the “job position” of the predetermined user and adding the name of the job position to the query, to rewrite the query as “please describe the precautions to be taken in the current job position. The name of the job position is X”, it is possible to cause the language model to generate an answer fit for the job position of the predetermined user. The adjusting section 102 substitutes the name of the detected job position for the “X” in the rewritten query.

### (Example Advantage of Information Processing Apparatus 1)

As above, the information processing apparatus 1 includes: a designating section 101 for designating data related to the job of a predetermined user as job-related data; and an adjusting section 102 for adjusting, with use of the job-related data, a language model having been trained by machine learning so as to output an answer to a query, such that the language model suits the predetermined user. The information processing apparatus 1 therefore provides an example advantage of making it possible to use a language model to generate an answer fit for the job of a predetermined user.

The language model thus adjusted can also be used in supporting the predetermined user in their decision-making. For example, a user can cause the language model to generate an answer to a question which is asked them. The answer thus generated has the content in accordance with the job-related data of the past concerning the user. The user can then use, as a guide, the answer which is generated via the language model and which is in accordance with the job-related data of the past concerning them, to determine how to answer the question.

The designating section 101 can also designate, for each of a plurality of users, data related to the job of that user, as the job-related data. The adjusting section 102 can also then use each job-related data designated, to adjust the language model such that the language model suits the corresponding user. In this case, a plurality of language models fit for the respective users are generated. Further, the adjusting section 102 can register, for each of the plurality of users, the job-related data corresponding to that user, as data to be referred to in generating an answer via the language model.

### (Configuration of Information Processing Apparatus 2)

The configuration of an information processing apparatus 2 will be described below with reference to FIG. 1 again. The information processing apparatus 2 includes an accepting section 201 and a responding section 202, as illustrated in FIG. 1.

The accepting section 201 accepts an input of a query. This query serves as an order to generate an answer to this query with use of a language model. For example, the accepting section 201 may accept, as the query, a question regarding the job of a predetermined user.

The responding section 202 generates an answer to the query accepted by the accepting section 201, via a language model having been trained by machine learning so as to output an answer to a query, the language model having been adjusted to suit a predetermined user with use of the job-related data related to the job of the predetermined user. This language model may be, for example, the language model having been adjusted by the adjusting section 102 of the information processing apparatus 1.

The responding section 202 may generate an answer to the query accepted by the accepting section 201, with use of the job-related data and a language model instead of using the language model having been adjusted by machine learning as described above. For example, the responding section 202 may search for job-related data which is related to the query, to add the detected job-related data to the query or rewrite the query on the basis of the detected job-related data. The responding section 202 may then input, to a language model, the query having undergone the addition or the rewrite, to generate an answer. Note that a location at which the job-related data used to generate an answer is referred to may be, for example, the location registered by the adjusting section 102 of the information processing apparatus 1.

### (Example Advantage of Information Processing Apparatus 2)

As above, the information processing apparatus 2 includes: an accepting section 201 for accepting an input of a query; and a responding section 202 for generating an answer to the query accepted by the accepting section 201, via a language model having been trained by machine learning so as to output an answer to a query, the language model having been adjusted to suit a predetermined user with use of job-related data related to a job of the predetermined user, or generating an answer to the query accepted by the accepting section 201, with use of the job-related data and a language model. The information processing apparatus 2 therefore provides an example advantage of making it possible to use a language model to generate an answer fit for the job of a predetermined user.

A plurality of language models fit for respective users may be prepared in advance. In this case, the responding section 202 generates the answer with use of a language model of the plurality of language models that corresponds to a target user in generating the answer. Further, for each of the plurality of users, a location at which the job-related data corresponding to that user is referred to may be registered. In this case, the responding section 202 generates the answer with use of a language model and the job-related data at a location of the registered locations that corresponds to the target user in generating the answer.

The information processing apparatuses 1 and 2 can be applied to the fields of medical care and health care. For example, medical examination data of a certain medical institution may be used as the job-related data. This even makes it possible to adjust a language model capable of generating an answer to a question regarding a medical examination, the answer being similar to that provided by medical personnel belonging to the medical institution. For example, the answer thus generated can be used as a second opinion.

### (Adjustment Program)

The functions of the information processing apparatus 1 above can be implemented via a program. An adjustment program in accordance with the present example embodiment causes a computer to function as: a designating means for designating data related to a job of a predetermined user as job-related data; and an adjusting means for adjusting, with use of the job-related data, a language model having been trained by machine learning so as to output an answer to a query, such that the language model suits the predetermined user. The adjustment program in accordance with the present example embodiment therefore provides an example advantage of making it possible to use a language model to generate an answer fit for the job of a predetermined user.

### (Response Program)

The above functions of the information processing apparatus 2 can also be implemented via a program. A response program in accordance with the present example embodiment causes a computer to function as: an accepting means for accepting an input of a query; and a responding means for generating an answer to the query accepted by the accepting means, via a language model having been trained by machine learning so as to output an answer to a query, the language model having been adjusted to suit a predetermined user with use of job-related data related to a job of the predetermined user, or generating an answer to the query accepted by the accepting means, with use of the job-related data and a language model. The response program in accordance with the present example embodiment therefore provides an example advantage of making it possible to use a language model to generate an answer fit for the job of a predetermined user.

### (Flow of Adjustment Method)

A flow of an adjustment method will be described below with reference to FIG. 2. FIG. 2 is a flowchart illustrating flows of an adjustment method and a response method. Each of the steps of the adjustment method illustrated in FIG. 2 may be carried out by a processor included in the information processing apparatus 1, or may be carried out by a processor included in another apparatus. Alternatively, the steps may be carried out by respective processors provided in different apparatuses. Similarly each of the steps of the response method illustrated in FIG. 2 may be carried out by a processor included in the information processing apparatus 2, or may be carried out by a processor included in another apparatus. Alternatively, the steps may be carried out by respective processors provided in different apparatuses.

As illustrated in a flow F1 of FIG. 2, the present adjustment method includes: a designating process S11 of at least one processor designating data related to the job of a predetermined user as job-related data; and an adjusting process S12 of the at least one processor adjusting, with use of the job-related data, a language model having been trained by machine learning so as to output an answer to a query, such that the language model suits the predetermined user.

### (Example Advantage of Adjustment Method)

As above, the present adjustment method includes: a designating process of at least one processor designating data related to a job of a predetermined user as job-related data; and an adjusting process of the at least one processor adjusting, with use of the job-related data, a language model having been trained by machine learning so as to output an answer to a query, such that the language model suits the predetermined user. The present adjustment method therefore provides an example advantage of making it possible to use a language model to generate an answer fit for the job of a predetermined user.

### (Flow of Response Method)

A flow of the present response method will be described below with reference to FIG. 2 again. As illustrated in a flow F2 of FIG. 2, the present response method includes: an accepting process S21 of at least one processor accepting an input of a query; and a responding process S22 of the at least one processor generating an answer to the query accepted in the accepting process S21, via a language model having been trained by machine learning so as to output an answer to a query, the language model having been adjusted to suit a predetermined user with use of job-related data related to the predetermined user, or generating an answer to the query accepted in the accepting process S21, with use of the job-related data and a language model.

### (Example Advantage of Response Method)

As above, the present response method includes: an accepting process of at least one processor accepting an input of a query; and a responding process of the at least one processor generating an answer to the query accepted in the accepting process, via a language model having been trained by machine learning so as to output an answer to a query, the language model having been adjusted to suit a predetermined user with use of job-related data related to the predetermined user, or generating an answer to the query accepted in the accepting process, with use of the job-related data and a language model. The present response method therefore provides an example advantage of making it possible to use a language model to generate an answer fit for the job of a predetermined user.

### (Configuration of Information Processing Apparatus 3)

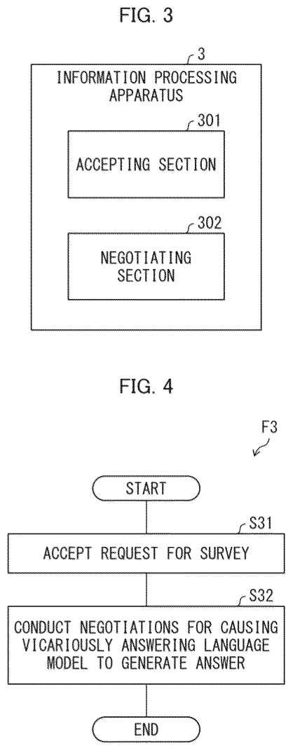

The configuration of an information processing apparatus 3 will be described below with reference to FIG. 3. FIG. 3 is a block diagram illustrating a configuration of the information processing apparatus 3. The information processing apparatus 3 includes an accepting section 301 and a negotiating section 302, as illustrated in FIG. 3.

The accepting section 301 accepts a request for a survey in which answers to a predetermined question are collected. The content of the survey and the content of the question are not particularly limited. As an example, the accepting section 301 may accept a request for a survey on marketing. As another example, the accepting section 301 may accept a request for a questionnaire survey targeting people belonging to a predetermined company and people of a predetermined job category such as medical personnel. The accepting section 301 may accept one or more requests from a single requester, or may be accept one or more requests for surveys from each of a plurality of requesters. The request for a survey only needs to contain at least one question to be answered. In the following description, a marketing survey is taken as an example. However, the content of a request accepted by the accepting section 301 is not limited to a survey, but any request can be accepted provided that the request is compatible with information which can be outputted by a language model.

The negotiating section 302 conducts, with a predetermined negotiating partner, negotiations for causing a vicariously answering language model to generate e an answer to a question, the vicariously answering language model having been trained by machine learning so as to be capable of generating an answer to an inputted question as a surrogate for a predetermined user. The predetermined negotiating partner may be a person (e.g. the above predetermined user), may be an apparatus (e.g. the above information processing apparatus 2), or may be the vicariously answering language model. The “negotiation” conducted by the negotiating section 302 may at least contain, for example: notifying the negotiating partner of at least one selected from the group consisting of a question the answer to which is asked to be generated and a condition as to the answer to the question; and receiving an answer to the notification from the negotiating partner.

The vicariously answering language model only needs to have been trained by machine learning so as to be capable of generating an answer as a surrogate for a predetermined user. For example, a language model adjusted by the above adjusting section 102 may be used as the vicariously answering language model. Further, a language model with which the above adjusting section 102 registers the job-related data concerning the predetermined user as data to be referred to in generating an answer may be used as the vicariously answering language model.

### (Example Advantage of Information Processing Apparatus 3)

As above, the information processing apparatus 3 includes: an accepting section 301 for accepting a request for a survey in which answers to a predetermined question are collected; and a negotiating section 302 for conducting, with a predetermined negotiating partner, negotiations for causing a vicariously answering language model to generate an answer to the predetermined question, the vicariously answering language model having been trained by machine learning so as to be capable of generating an answer to an inputted question as a surrogate for a predetermined user. Thus, the information processing apparatus 3 provides an example advantage of making it possible to easily conduct a survey in which answers to a predetermined question are collected. In addition, the information processing apparatus 3 makes it possible to optimize respondents of a question. For example, by negotiating with a plurality of respondents, i.e. vicariously answering language models, the information processing apparatus 3 makes it possible to cause an optimum vicariously answering language model to generate an answer.

### (Intermediary Program)

The functions of the information processing apparatus 3 above can be implemented via a program. An intermediary program in accordance with the present example embodiment causes a computer to function as: an accepting means for accepting a request for a survey in which answers to a predetermined question are collected; and a negotiating means for conducting, with a predetermined negotiating partner, negotiations for causing a vicariously answering language model to generate an answer to the predetermined question, the vicariously answering language model having been trained by machine learning so as to be capable of generating an answer to an inputted question as a surrogate for a predetermined user. Thus, the intermediary program in accordance with the present example embodiment provides an example advantage of making it possible to easily conduct a survey in which answers to a predetermined question are collected.

### (Flow of Intermediary Method)

A flow of an intermediary method will be described below with reference to FIG. 4. As illustrated in a flow F3 of FIG. 4, the present intermediary method includes: an accepting process S31 of at least one processor accepting a request for a survey in which answers to a predetermined question are collected; and a negotiating process S32 of the at least one processor conducting, with a predetermined negotiating partner, negotiations for causing a vicariously answering language model to generate an answer to the question, the vicariously answering language model having been trained by machine learning so as to be capable of generating an answer to an inputted question as a surrogate for a predetermined user.

### (Example Advantage of Intermediary Method)

As above, the present intermediary method includes: an accepting process of at least one processor accepting a request for a survey in which answers to a predetermined question are collected; and a negotiating process of conducting, with a predetermined negotiating partner, negotiations for causing a vicariously answering language model to generate an answer to the predetermined question, the vicariously answering language model having been trained by machine learning so as to be capable of generating an answer to an inputted question as a surrogate for a predetermined user. Thus, the present intermediary method provides an example advantage of making it possible to easily conduct a survey in which answers to a predetermined question are collected.

### Second Example Embodiment

The following description will discuss a second example embodiment, which is an example embodiment of the present invention, in detail with reference to the drawings. A component having the same function as a component described in the above example embodiment is assigned the same reference sign, and the description thereof is omitted where appropriate. It should be noted that the applicable scope of each technical means adopted in the present example embodiment is not limited to the present example embodiment. That is, each technical means adopted in the present example embodiment can be adopted in another example embodiment included in the present disclosure, to the extent of constituting no specific technical obstacle. Further, each technical means illustrated in the drawings which are referred to for describing the present example embodiment can be adopted in another example embodiment included in the present disclosure, to the extent of constituting no specific technical obstacle. These matters hold true for a third example embodiment which will be described later.

### (Configuration of Information Processing Apparatus 1A)

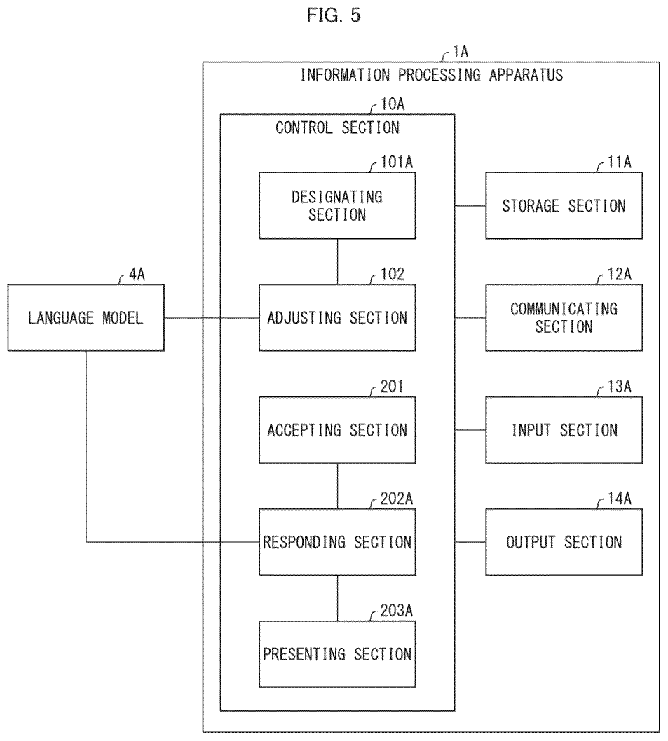

The configuration of an information processing apparatus 1A will be described below with reference to FIG. 5. FIG. 5 is a block diagram illustrating a configuration of the information processing apparatus 1A. The information processing apparatus 1A includes: a control section 10A for performing overall control of the sections of the information processing apparatus 1A; and a storage section 11A for storing various kinds of data used by the information processing apparatus 1A, as illustrated. In addition, the information processing apparatus 1A includes: a communicating section 12A via which the information processing apparatus 1A communicates with another apparatus; an input section 13A for accepting an input, to the information processing apparatus 1A, of various kinds of data; and an output section 14A via which the information processing apparatus 1A outputs various kinds of data. Further, the control section 10A includes: a designating section 101A, an adjusting section 102, an accepting section 201, a responding section 202A, and a presenting section 203A, as illustrated.

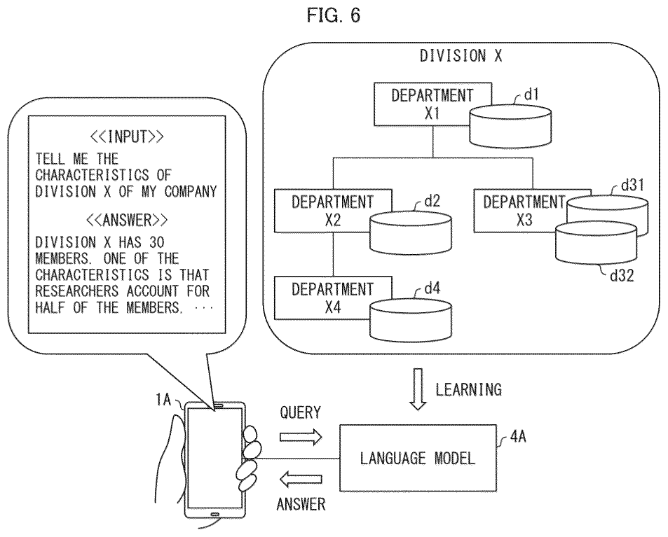

Like the designating section 101 of the information processing apparatus 1, the designating section 101A designates data related to a job of a predetermined user as job-related data. The designating section 101A differs from the designating section 101 in that hierarchy information indicating the hierarchy of an organization to which the predetermined user belongs is used for designating the job-related data. The details of this will be described on the basis of FIG. 6.

Like the responding section 202 of the information processing apparatus 2, the responding section 202A generates an answer to a query inputted by the predetermined user, with use of a language model. The responding section 202A differs from the responding section 202 in that a language model 4A is used which is generated or updated with use of the job-related data designated with use of the hierarchy information.

The language model 4A is a language model having been trained by machine learning so as to output an answer to a query. The language model 4A has been adjusted by the adjusting section 102 with use of the job-related data, so as to be fit for the predetermined user. Note that a language model to which such an adjustment has not been made but which has been trained by machine learning so as to output an answer to a query may be applied as the language model 4A. In this case, the job-related data concerning the predetermined user is registered by the adjusting section 102 as data to be referred to in generating an answer with use of the language model 4A, so as to be associated with the language model 4A. The responding section 202A then uses the job-related data and the language model 4A to generate an answer to a query. Although the language model 4A is illustrated so as to be outside the information processing apparatus 1A in FIG. 5, the language model 4A may be stored in the inside (e.g. the storage section 11A) of the information processing apparatus 1A.

The presenting section 203A presents to the predetermined user the answer generated by the responding section 202A. The manner in which the answer is presented is not particularly limited. For example, the presenting section 203A may present the answer by display output through displaying equipment, may present the answer by audio output through audio output equipment, or may present the answer by print output through a printing equipment. The equipment (e.g. the above displaying equipment, audio output equipment, or printing equipment) through which the answer is presented may be included in the information processing apparatus 1A, or may be external to the information processing apparatus 1A.

The information processing apparatus 1A is capable of both generating an answer with use of the language model 4A and making an adjustment regarding the language model 4A (update of the language model 4A or the addition of the job-related data to be referred to). Thus, the information processing apparatus 1A is capable of making an adjustment regarding a language model with use of a query inputted by a user. Note that as in the first example embodiment, the apparatus (corresponding to the information processing apparatus 1) for making an adjustment regarding a language model and the apparatus (corresponding to the information processing apparatus 2) for generating an answer with use of the language model may be separate apparatuses independent of each other.

### (Example Operation)

An example operation of the information processing apparatus 1A will be described below on the basis of FIG. 6. FIG. 6 is a representation of an example operation of the information processing apparatus 1A. Illustrated in FIG. 6 is an example in which the information processing apparatus 1A is a smartphone. The information processing apparatus 1A only needs to be an apparatus via which it is possible to implement the functions of respective functional blocks illustrated in FIG. 5, and is not limited to a smartphone.

The information processing apparatus 1A accepts an input of a query, generates an answer to the query, and presents the answer generated. Assume, for example, that the predetermined user using the information processing apparatus 1A inputs a query “tell me the characteristics of the division X of my company”, as illustrated in FIG. 6. In this case, the accepting section 201 of the information processing apparatus 1A accepts an input of the query, the responding section 202A generates an answer to this query with use of the language model 4A, and the presenting section 203A displays the answer on a displaying section included in the information processing apparatus 1A.

The language model 4A illustrated in FIG. 6 is a language model having been trained by machine learning so as to output an answer to a query, the language model having been adjusted to suit the predetermined user with use of job-related data related to the job of the predetermined user. This language model 4A differs from the language model described in the first example embodiment in that the language model 4A is a model generated or updated with use of the job-related data designated by the designating section 101A with use of the hierarchy information.

As above, the designating section 101A differs from the information processing apparatus 1 in that the hierarchy information indicating the hierarchy of an organization to which the predetermined user belongs is used in designating the job-related data. More specifically, the designating section 101A uses the hierarchy information to designate a level having a predetermined relationship with the level to which the predetermined user belongs, and designates the job-related data related to the level designated.

FIG. 6 schematically illustrates the hierarchy of the departments contained in the division X of the company to which the predetermined user belongs. As illustrated, the division X contains departments X1 to X4. The department X1 belongs to the highest level, and the departments X2 and X3 belong to the level directly subordinated to department X1. To the level below the department X2, the department X4 belongs. The hierarchy information may indicates such a hierarchy of the departments, i.e. the levels to which the respective departments belong and the relationship between the levels.

In FIG. 6, pieces of job-related data d1, d2, d31 and d32, and d4 related to the respective departments X1 to X4 are illustrated as example of the usable job-related data in training the language model 4A. Any of these pieces of data can be said to be related to the job of the predetermined user in a broad sense. However, these pieces of data can contain data having low relatedness to the job of the predetermined user. As such, the designating section 101A uses the hierarchy information to designate job-related data having high relatedness to the job of the predetermined user from among these pieces of job-related data. This makes it possible to improve the fitness of the language model 4A for the job of the predetermined user.

Assume, for example, that the predetermined user belongs to the department X2. In this case, the designating section 101A may designate the job-related data d4 (related to the department X4 belonging to the level directly subordinated to the department X2) as the job-related data to be used for generation or update of the language model 4A, in addition to the job-related data d2 (related to the department X2). Further, the designating section 101A may designate the job-related data d1 (related to the department X1 belonging to the level directly superior to the department X2) as the job-related data to be used for generation or update of the language model 4A, in addition to or instead of the job-related data d4. Furthermore, the designating section 101A may designate the job-related data d31 and d32 (related to the department X3 at the same level as the department X2) as the job-related data to be used for generation or update of the language model 4A, in addition to or instead of the job-related data d4.

Job-related data related to a department can contain data which is suitable to be shared and data which is not suitable to be shared. Therefore, with the degree of confidentiality of each job-related data set in advance, the designating section 101A may designate job-related data according to the set degree of confidentiality as the job-related data to be used for generation or update of the language model 4A.

Assume, for example, that in FIG. 6, the degree of confidentiality of the job-related data d31 is set to “1” and the degree of confidentiality of the job-related data d32 is set to “0”. In this context, “1” indicates that data should be kept confidential and “0” indicates that data does not need to be kept confidential. In this case, the designating section 101A designates the job-related data d32 as the job-related data to be used for generation or update of the language model 4A, but does not designate the job-related data d31 as the job-related data to be used for generation or update of the language model 4A. This makes it possible to prevent job-related data which should be kept confidential from being leaked via the output of the language model 4A due to the use of such confidential job-related data in training the language model 4A.

The degree of confidentiality may indicate whether to keep the data confidential, or may indicate a degree to which the data should be kept confidential. In the latter case, the upper limit of the degree of confidentiality of the job-related data which is allowed to be used may be determined for each user. In this case, the information processing apparatus 1A can use the job-related having a degree of confidentiality determined according to the user, to generate or update the language model 4A.

The adjusting section 102 of the information processing apparatus 1A uses the job-related data designated as described above by the designating section 101A, to generate or update the language model 4A. This makes it possible to provide the language model 4A fit for the hierarchy of an organization to which a predetermined user belongs.

Instead of generating or updating the language model 4A, the adjusting section 102 may make an adjustment of registering, as data to be referred to in the responding section 202A generating an answer with use of the language model, the job-related data designated by the designating section 101A. In this case, the language model as in the first example embodiment may be applied as the language model 4A.

As above, the designating section 101A designates a level having a predetermined relationship with the level to which a predetermined user belongs, with use of the hierarchy information indicating the hierarchy of an organization to which the predetermined user belongs, and designates job-related data related to the level designated. Thus, the information processing apparatus 1A provides an example advantage of making it possible to designate job-related data useful in adjusting the language model 4A in consideration of the hierarchy of an organization to which a user belongs, in addition to the example advantages provided by the information processing apparatus 1.

As described above, the designating section 101A may designate the job-related data according to the set degree of confidentiality of each data related to the job of a predetermined user. This provides an example advantage of making it possible to provide phased use of job-related data which is in accordance with the degree of confidentiality, in addition to the example advantage provided by the information processing apparatus 1.

### (Flow of Processes in Adjusting Language Model 4A)

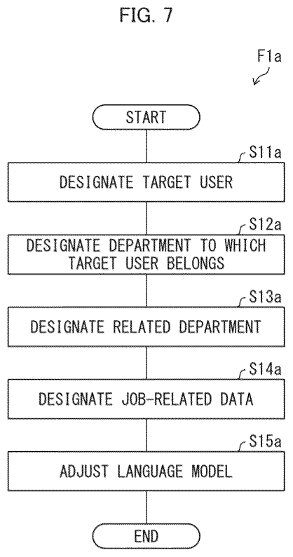

A flow of processes carried out by the information processing apparatus 1A in adjusting the language model 4A will be described below on the basis of FIG. 7. FIG. 7 is a flowchart illustrating a flow of processes in which the information processing apparatus 1A adjusts the language model 4A.

In S11a in a flow Fla illustrated in FIG. 7, the designating section 101A designates a predetermined user as a target user. A method for designating the predetermined user is not particularly limited. For example, identification information regarding the predetermined user may be inputted by an operator of the information processing apparatus 1A via the communicating section 12A or the input section 13A. In this case, the designating section 101A designates, as the predetermined user, a user identified with the inputted identification information.

In S12a, the designating section 101A designates the department to which the user designated in S11a belongs. A method for designating a department to which the user belongs is not particularly limited. For example, information indicating the department to which the user belongs may be inputted by a user of the information processing apparatus 1A via the communicating section 12A or the input section 13A. In this case, the designating section 101A designates, as the department to which the predetermined user belongs, the department indicated in the inputted information.

In S13a, the designating section 101A designates a level having predetermined relationship with the level to which the department designated in S12a belongs. The designating section 101A then designates a department belonging to the designated level, i.e. a related department. For example, the designating section 101A may designate, as the related department, any of a department at the same level as the department to which the predetermined user belongs, a department at a higher level than the department to which the predetermined user belongs, and a department at a lower level than the department to which the predetermined user belongs. In a case where the job-related data is managed by level, the designating section 101A only need to designate the related level alone, without the need to designate the related department.

In S14a, the designating section 101A designates data related to the job of the predetermined user as job-related data. More specifically, the designating section 101A designates, as the job-related data, data related to the related department designated in S13a from among pieces of data related to the job of the predetermined user. Note that the data related to the related department can also be said to be data related to a level related to the level to which the user belongs.

In S15a, the adjusting section 102 uses the job-related data designated in S14a to adjust the language model having been trained by machine learning so as to output an answer to a query such that the language model suits the predetermined user. As an example, the adjusting section 102 may generate the language model 4A with use of the job-related data designated in S14a. As another example, the adjusting section 102 may generate the language model 4A by updating the language model having been trained by machine learning so as to output an answer to a query, with use of the job-related data designated in S14a. The language model 4A generated is stored in predetermined storage, and the processing of the flow Fla ends. Further, the adjusting section 102 may adjust the language model such that the language model suits the predetermined user, by registering, as data to be referred to in generating an answer via a language model, the job-related data designated in S14a.

### (Flow of Processes Carried Out in Answering Query)

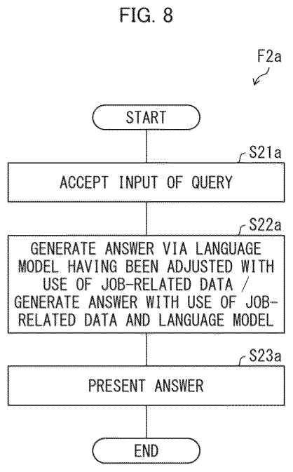

A flow of processes carried out by the information processing apparatus 1A in generating an answer to a query and presenting the answer will be described below on the basis of FIG. 8. FIG. 8 is a flowchart illustrating a flow of processes carried out by the information processing apparatus 1A in generating and presenting an answer to a query.

In S21a in a flow F2a illustrated in FIG. 8, the accepting section 201 accepts an input of a query. In this acceptance, the presenting section 203A may display a UI screen for accepting the input of a query on, for example, a displaying section of a terminal possessed by the predetermined user. In this case, the accepting section 201 accepts the input of a query via the terminal. Note that the accepting section 201 may accept the input of a query via the input section 13A.

In S22a, the responding section 202A uses the language model 4A generated with use of the job-related data concerning the predetermined user, to generate an answer to the query inputted in S21a. Note that the responding section 202A may generate the answer with use of the job-related data concerning the predetermined user who inputs the query in S21a and a language model having been trained by machine learning so as to output an answer to a query.

In S23a, the presenting section 203A presents the answer generated in S22a. For example, in a case of accepting the input of a query via a terminal, the presenting section 203A may output the answer on the terminal. Further, the presenting 203A may present the answer via the output section 14A. The processing of the flow F2a thus ends.

Respective language models 4A fit for a plurality of users may be prepared in advance. In this case, in S21a, the accepting section 201 identifies a target user by prompting a user to input the identification information regarding the user. In S22a, the responding section 202A then generates an answer with use of the language model 4A which is fit for the identified user. Alternatively, instead of preparing the respective language models 4A fit for a plurality of users, locations at which the respective pieces of job-related data concerning the plurality of users are referred to may be registered. In this case, in S22a, the responding section 202A generates the answer with use of the job-related data designated by referring to the location corresponding to the identified user.

### Third Example Embodiment

### (Configuration of Survey System 7B)

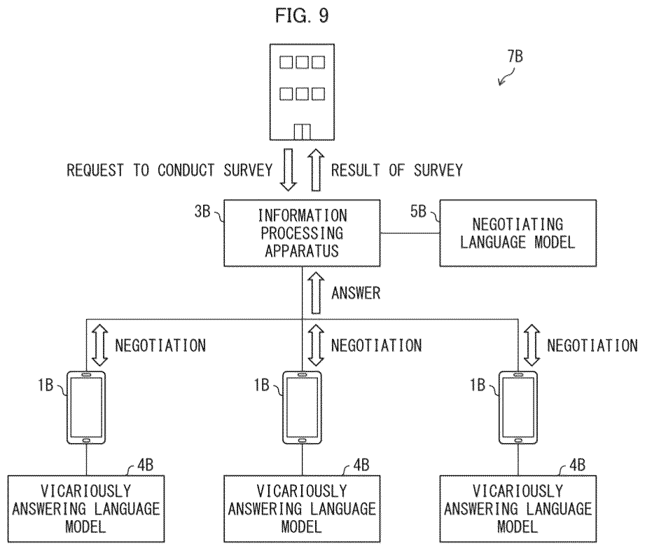

The configuration of a survey system 7B will be described below with reference to FIG. 9. FIG. 9 is a representation of a configuration of the survey system 7B. The survey system 7B is a system for accepting a request to conduct a survey and outputting a survey result. The survey system 7B includes an information processing apparatus 1B and an information processing apparatus 3B, as illustrated. Note that the numbers of information processing apparatuses 1B and information processing apparatuses 3B included in the survey system 7B are each any number, and do not limited to the example illustrated.

In the survey system 7B, the information processing apparatus 3B accepts a request for a survey in which answers to a predetermined question are collected. The information processing apparatus 3B then negotiates with the information processing apparatus 1B on a condition for causing a vicariously answering language model 4B to generate an answer to the question. In this negotiation, a negotiating language model 5B is used. In this manner, the information processing apparatus 3B functions as an intermediary apparatus for acting as an intermediary between the information processing apparatus 1B and a requester of the survey.

The vicariously answering language model 4B is a language model having been trained by machine learning so as to be capable of generating, as a surrogate for a predetermined user, an answer to an inputted question. The information processing apparatus 1B uses the vicariously answering language model 4B to serve as a surrogate or a private secretary of the user of the information processing apparatus 1B. For example, the information processing apparatus 1B accepts an input of a question asked the user of the information processing apparatus 1B, and judges whether to cause the vicariously answering language model 4B to generate an answer to the question. Each information processing apparatus 1B has associated therewith the corresponding vicariously answering language model 4B which generates an answer as a surrogate for the user of the information processing apparatus 1B.

The vicariously answering language model 4B only needs to have been trained by machine learning so as to be capable of generating an answer as a surrogate for a predetermined user. For example, a language model adjusted by the above adjusting section 102 may be used as the vicariously answering language model 4B. Further, a language model with which the above adjusting section 102 registers the job-related data concerning the predetermined user as data to be referred to in generating an answer may be used as the vicariously answering language model 4B.

It is preferable to make it impossible for anything and anyone other than the information processing apparatus 3B and the user of the information processing apparatus 1B to have access to the information processing apparatus 1B. This makes it possible to prevent information on the user from being leaked through the vicariously answering language model 4B.

As above, the survey system 7B includes: an information processing apparatus 1B for accepting an input of a query and generating an answer to the query via a vicariously answering language model 4B that is a language model which has been trained by machine learning so as to output an answer to a query and which has been adjusted to suit a predetermined user with use of job-related data related to the job of the predetermined user; and an information processing apparatus 3B that is an intermediary apparatus for accepting a request for a survey in which answers to a predetermined question are collected and conducting, with the information processing apparatus 1B, negotiations for causing the vicariously answering language model 4B to generate an answer to the predetermined question. This survey system 7B provides an example advantage of making it possible to easily conduct a survey in which answers to a predetermined question are collected.

The information processing apparatus 1B may generate an answer to a query with use of job-related data and the vicariously answering language model 4B. In this case, the vicariously answering language model 4B only needs to be a language model having been trained by machine learning so as to output an answer to a query, and does not need to be adjusted with use of the job-related data related to the job of a predetermined user. A location at which job-related data to be used in generating an answer is referred to only needs to be registered so as to be associated with the vicariously answering language model 4B.

### (Configuration of Information Processing Apparatus 1B)

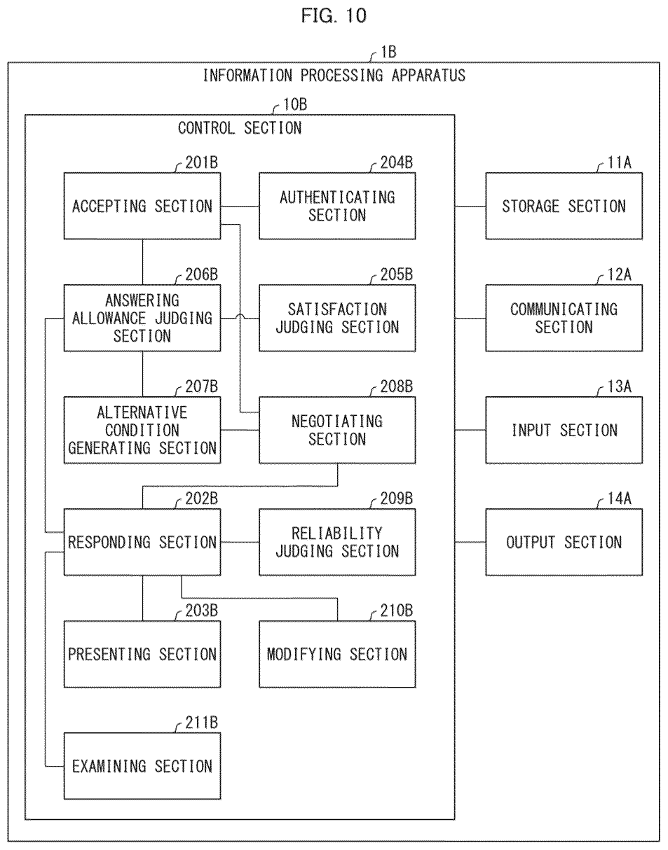

The configuration of an information processing apparatus 1B will be described below with reference to FIG. 10. FIG. 10 is a block diagram illustrating a configuration of the information processing apparatus 1B. As illustrated, the information processing apparatus 1B includes a control section 10B for performing overall control of the sections of the information processing apparatus 1B. The control section 10B includes an accepting section 201B, a responding section 202B, a presenting section 203B, an authenticating section 204B, a satisfaction judging section 205B, an answering allowance judging section 206B, an alternative condition generating section 207B, a negotiating section 208B, a reliability judging section 209B, a modifying section 210B, and an examining section 211B.

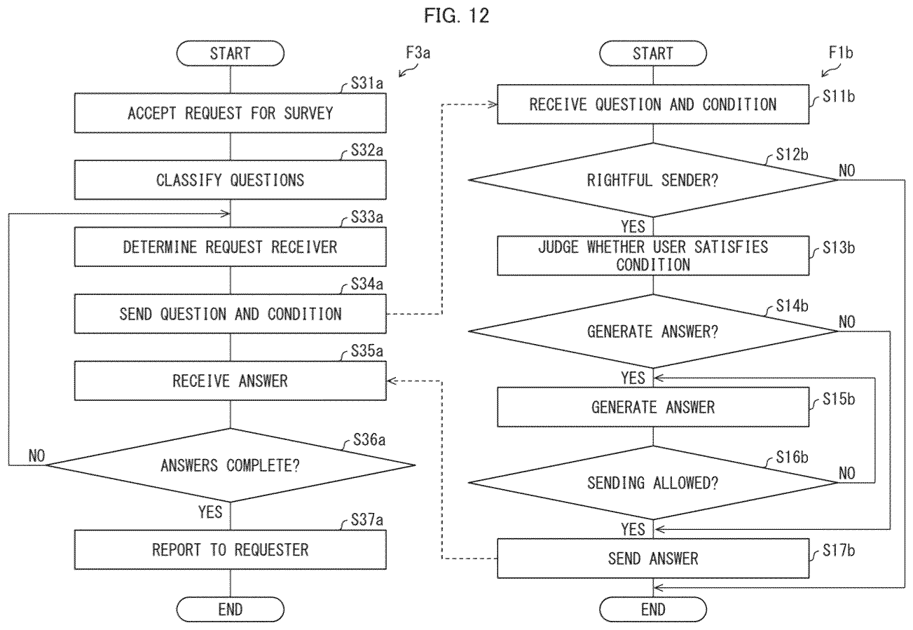

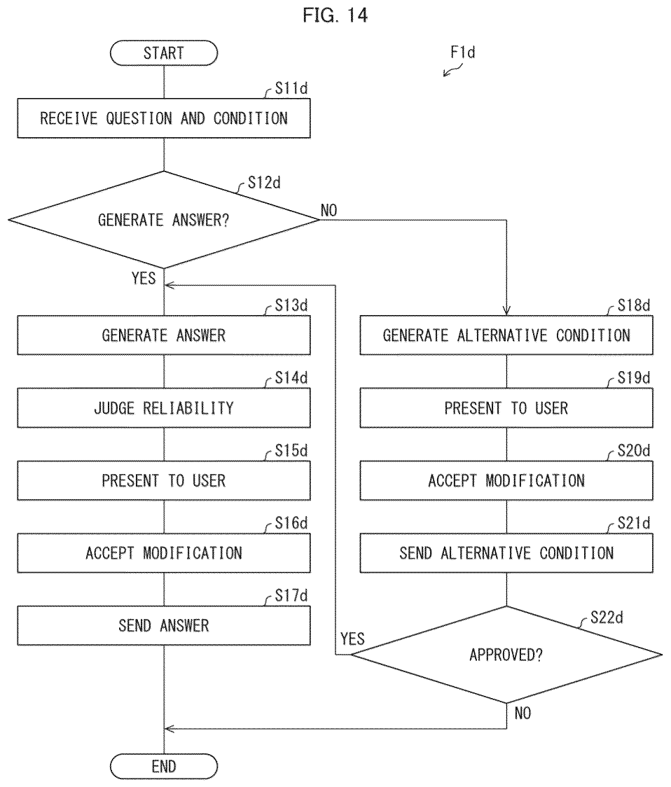

The information processing apparatus 1B may include the designating section 101 or 101A and the adjusting section 102. The details of the answering allowance judging section 206B and the examining section 211B will be described later on the basis of FIG. 12, and the details of the alternative condition generating section 207B, the reliability judging section 209B, and the modifying section 210B will be described later on the basis of FIG. 14. The following are the descriptions of the other components.

The accepting section 201B accepts an input of a query, like the accepting section 201 of the information processing apparatus 2. For example, the accepting section 201B accepts an input of a question asked a predetermined user. The predetermined user is a user which corresponds to the vicariously answering language model 4B used by the information processing apparatus 1B.

The accepting section 201B may accept not only the question but also a condition as to an answer to the question. The condition is set as appropriate by a requester. For example, this condition may include at least one selected from the group consisting of a reward for providing an answer, an answering method (e.g. multiple choice or free response, or any other answering type), whether an additional question is permitted, an attribute of a respondent (e.g. an area of expertise, work experience, a possessed qualification, etc.), and the scope of information to be contained in an answer. The scope of information to be contained in an answer may be determined on the basis of, for example, the set degree of confidentiality of each information.

Like the responding section 202 of the information processing apparatus 2, the responding section 202B generates an answer to the query accepted by the accepting section 201B, via a language model (specifically, the vicariously answering language model 4B) which has been trained by machine learning so as to output an answer to a query and which has been adjusted to suit a predetermined user with use of job-related data related to the job of the predetermined user. Alternatively, the responding section 202B may generate an answer with use of the job-related data concerning the predetermined user and the vicariously answering language model 4B which has not undergone an adjustment to suit the predetermined user, instead of using the vicariously answering language model 4B which has been trained by machine learning so as to be fit for the predetermined user.

The presenting section 203B presents to the user the answer generated by the responding section 202B. The manner in which the answer is presented is not particularly limited. For example, the presenting section 203B may present an image indicating the content of the answer by display output through displaying equipment, may present sound indicating the content of the answer by audio output through audio output equipment, or may present the content of the answer by print output through a printing equipment. The equipment (e.g. the above displaying equipment, audio output equipment, or printing equipment) which through the answer is presented may be included in the information processing apparatus information processing apparatus 1B, or may be external to the information processing apparatus 1B.

The authenticating section 204B judges whether the sender of a question is rightful when the accepting section 201B accepts an input of the question. Specifically, in a case where the sender of a question the input of which is accepted by the accepting section 201B is the information processing apparatus 3B, the authenticating section 204B judges that the sender is a rightful sender, and in a case where the sender is not the information processing apparatus 3B, the authenticating section 204B judges that the sender is not a rightful sender. A method for judging whether the sender of a question is the information processing apparatus 3B is not particularly limited. As an example, the information processing apparatus 3B may be caused to send its identification information, and in this case, the authenticating section 204B may use the received identification information to judge whether the sender of a question is the information processing apparatus 3B. As another example, the authenticating section 204B may apply a technique such as a blockchain to judge whether the sender of a question is the information processing apparatus 3B.

The satisfaction judging section 205B judges whether the user of the information processing apparatus 1B satisfies the condition accepted by the accepting section 201B. For example, in a case where an attribute of a respondent is specified in the condition accepted by the accepting section 201B, the satisfaction judging section 205B refers to attribute information indicating an attribute of the user of the information processing apparatus 1B, to judge whether the condition is satisfied. Assume, for example, that the specified attribute of a respondent is at least a predetermined number of years of practical experience at a certain department. In this case, the satisfaction judging section 205B refers to the attribute information indicating the work experience of the user of the information processing apparatus 1B, to judge whether the condition is satisfied. Similarly, an extent to which answering a question is allowed (e.g. the degree of confidentiality of information which is allowed to be contained in an answer, etc.) may be registered as the attribute information in advance.

The satisfaction judging section 205B may judge an attribute of user of the information processing apparatus 1B from job history data concerning the user, or the like, and on the basis of the result of the judgment, judge whether the condition is satisfied. Assume, for example, that a respondent belonging to a predetermined area of expertise is stipulated as the condition. In this case, the satisfaction judging section 205B may judge, from the job history data concerning the user of the information processing apparatus 1B, the degree of agreement between the area of expertise of the user and the area of expertise indicated in the condition. In this manner, the satisfaction judging section 205B may judge a degree to which the condition is satisfied, not whether the condition is satisfied.

In a case where the reward for answering a question is stipulated as the condition, when the desired reward of the user of the information processing apparatus 1B is stipulated, the satisfaction judging section 205B may judge that the condition is satisfied, and when the desired reward is not stipulated, the satisfaction judging section 205B may judge that the condition is not satisfied. Note that, the user's desire may be stored in advance in the storage section 11A, etc. Further, the satisfaction judging section 205B may judge a degree to which the condition as to a reward is satisfied. Furthermore, the satisfaction judging section 205B may judge, for each of a plurality of conditions, whether that condition is satisfied or a degree to which that condition is satisfied. The satisfaction judging section 205B may then judge the overall degree of satisfaction on the basis of the results of the judgments on the respective conditions.

The negotiating section 208B negotiates with the information processing apparatus 3B for whether to cause the vicariously answering language model 4B to generate an answer to the question accepted by the accepting section 201B. For example, the negotiating section 208B carries out processes such as a process of inquiring of the information processing apparatus 3B about a question and a condition, and a process of notifying the information processing apparatus 3B of an alternative condition to inquire of the information processing apparatus 3B whether to approve of the alternative condition.

### (Configuration of Information Processing Apparatus 3B)

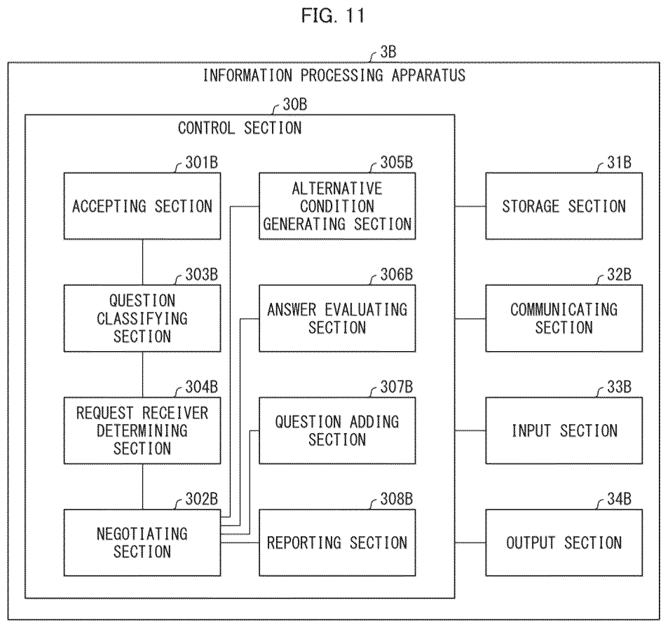

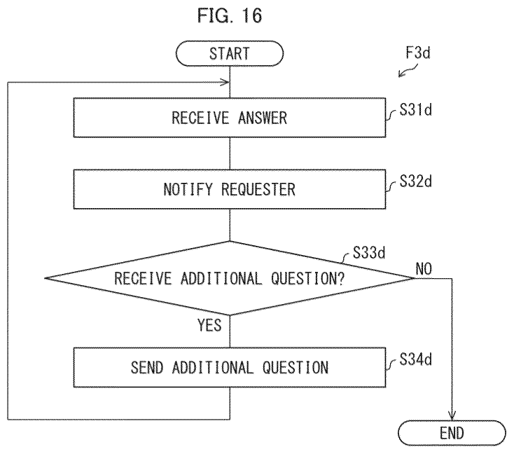

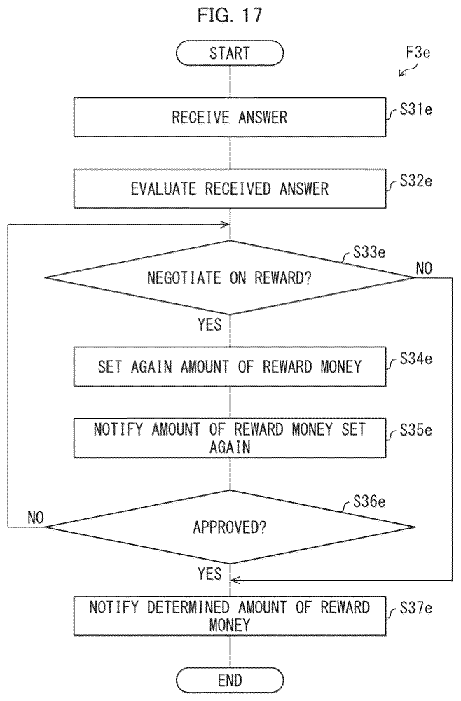

The configuration of the information processing apparatus 3B will be described below with reference to FIG. 11. FIG. 11 is a block diagram illustrating a configuration of the information processing apparatus 3B. The information processing apparatus 3B includes: a control section 30B for performing overall control of the sections of the information processing apparatus 3B; and a storage section 31B for storing various kinds of data used by the information processing apparatus 3B, as illustrated. In addition, the information processing apparatus 3B includes: a communicating section 32B via which the information processing apparatus 3B communicates with another apparatus; an input section 33B for accepting an input, to the information processing apparatus 3B, of various kinds of data; and an output section 34B via which the information processing apparatus 3B outputs various kinds of data. Further, as illustrated, the control section 30B includes an accepting section 301B, a negotiating section 302B, a question classifying section 303B, a request receiver determining section 304B, an alternative condition generating section 305B, an answer evaluating section 306B, a question adding section 307B, and a reporting section 308B. The answer evaluating section 306B will be described later on the basis of FIG. 17, and the question adding section 307B will be described later on the basis of FIG. 16.

The accepting section 301B accepts a request for a survey in which answers to a predetermined question are collected, like the accepting section 301 of the information processing apparatus 3. The accepting section 301B may accept not only the question but also a condition as to an answer to the question.

Like the negotiating section 302 of the information processing apparatus 3, the negotiating section 302B conducts, with a predetermined negotiating partner, negotiations for causing the vicariously answering language model 4B to generate an answer to a question, the vicariously answering language model 4B having been trained by machine learning so as to be capable of generating, as a surrogate for a predetermined user, an answer to an inputted question. The predetermined negotiating partner may be a person (e.g. the above predetermined user), may be an apparatus, or may be the vicariously answering language model 4B. In the present example embodiment, an example in which the predetermined negotiating partner is the information processing apparatus 1B will be mainly described.

For example, the negotiating section 302B may provide the predetermined negotiating partner with a notification of a condition as to an answer to a question in the survey accepted by the accepting section 301B, the condition being associated with the question, and on the basis of an answer to the notification received from the negotiating partner, determine whether to ask the negotiating partner for an answer to the question. This provides an example advantage of making it possible to automatically negotiate in consideration of a condition as to an answer, in addition to the example advantage provided by the information processing apparatus 3.

As above, the condition is set as appropriate by a requester. As an example, this condition may include at least one selected from the group consisting of a reward for providing an answer, an answering method, whether an additional question is permitted, an attribute of a respondent, and the scope of information to be contained in an answer. This provides an example advantage of making it possible to automatically negotiate in consideration of the conditions as described above, which are important matters in the negotiations, in addition to the example advantage provided by the information processing apparatus 3.

As another example, the negotiating section 302B may conduct the negotiations with use of the negotiating language model 5B which is generated by machine learning in which used as the training data are words exchanged in human-to-human negotiations, i.e. a negotiation history represented in a natural language. This provides an example advantage of making it possible to use the negotiating language model 5B to enable negotiations the contents of which are similar to those of human-to-human negotiations, in addition to the example advantage provided by the information processing apparatus 3. The training data for the negotiating language model 5B may contain words or sentences other than the words exchanged in human-to-human negotiations. It is also possible to negotiate with use of the negotiating language model 5B which is generated without using a negotiation history represented in a natural language as the training data.

The question classifying section 303B classifies questions contained in a plurality of requests accepted by the accepting section 301B, according to the targeted persons of the questions. With this classification, the questions contained in the plurality of requests are organized by targeted person. The targeted person of a question may be stipulated as, for example, a condition for answering a question. For example, in a case where there are a plurality of questions for which at least a predetermined number of years of practical experience at a certain department is stipulated as a condition as to a respondent, the question classifying section 303B may classify these questions as the same classification. In a case where the question classifying section 303B has classified the questions, the negotiating section 302B conducts negotiations on questions classified as the same classification, with a negotiating partner which corresponds to the classification.

The request receiver determining section 304B determines a request receiver to be requested to answer a question. The request receiver is selected from among a plurality of information processing apparatuses 1B (which can be restated as the vicariously answering language models 4B). Further, when the question classifying section 303B classifies questions, the request receiver determining section 304B determines, for each of the classifications of the questions, a request receiver to be requested to answer.

The request receiver determining section 304B may determine a request receiver on the basis of the result of the negotiations conducted by the negotiating section 302B. For example, the request receiver determining section 304B may determine that the request receivers are some or all of the information processing apparatuses 1B that are included in the information processing apparatuses 1B with which the negotiating section 302B has negotiated and that have approved of answering a question. Further, the request receiver determining section 304B may determine a request receiver (which can be restated as a negotiating partner in this case) prior to the negotiations conducted by the negotiating section 302B.

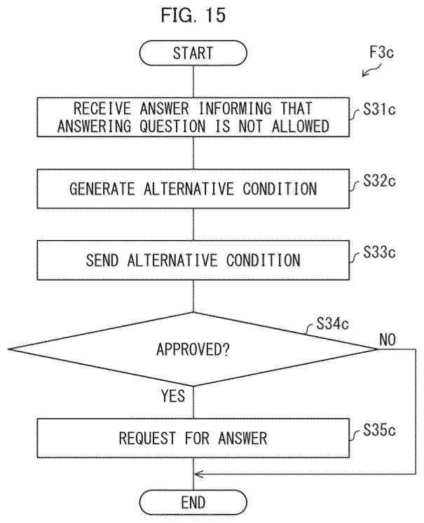

In a case of the failure to gain approval for answering a question from a negotiating partner, the alternative condition generating section 305B generates an alternative condition as to an answer to the question. A method of the alternative condition generating section 305B generating an alternative condition will be described later on the basis of FIG. 15.

The reporting section 308B reports to a requester on an answer obtained by the negotiating section 302B from the information processing apparatus 1B as a result of the above negotiations. Further, the form of the report is not particularly limited. For example, the reporting section 308B may notify the requester of an answer obtained from the information processing apparatus 1B as it is. Further, the reporting section 308B may compile answers obtained from the information processing apparatus 1B to generate a report, and send the generated report to the requester. The report may contain statistics based on the result of the above compilation, a graph generated with use of the statistics, a keyword extracted from the answers, an abstract of the result of the compilation, etc. It is also possible for the reporting section 308B to generate such a report with use of, for example, a language model.

### (Flow of Processes in Survey System 7B)

A flow of processes in the survey system 7B will be described below on the basis of FIG. 12. FIG. 12 is a flowchart illustrating a flow of the processes in the survey system 7B. Illustrated in FIG. 12 are a flow F3a carried out by the information processing apparatus 3B and a flow F1b carried out by the information processing apparatus 1B.

In S31a of the flow F3a, the accepting section 301 of the information processing apparatus 3B accepts a request for a survey in which answers to a predetermined question are collected. For example, the accepting section 301 may accept a request for a survey from a single requester, as in the example of FIG. 9, or may accept a request for a survey from each of a plurality of requesters. Further, the accepting section 301 may accept a plurality of requests for surveys from a single requester.

The request for a survey accepted by the accepting section 301B contains a condition as to an answer, in addition to a question to be answered. Any condition can be set as the condition. For example, at least one selected from the group consisting of the presence or absence of a reward for providing an answer, the content of the reward (in a case of monetary reward, the money amount of the reward or the like), an answering method (e.g. multiple choice or free response, or any other answering type), whether an additional question is permitted, an attribute of a respondent (e.g. a gender, an age, a department to which the respondent belongs, an area of expertise, etc.), and the degree of confidentiality of information to be contained in an answer may be set as the condition.

In S32a, the question classifying section 303B classifies questions contained in the request accepted in S31a according to targeted persons of the questions. Note that in a case where a plurality of requests are accepted in S31a, the question classifying section 303B classifies the questions contained in each of the requests. With this classification, the plurality of questions are compiled by targeted person.

In S33a, for each of the classifications in S32a, the request receiver determining section 304B determines a request receiver to be requested to answer the question. The request receiver is selected from among a plurality of information processing apparatuses 1B (which can be restated as the vicariously answering language models 4B).

A method for determining a request receiver in S33a may be determined in advance. As an example, in a case of determining a request receiver for each of the classifications of the questions, the request receiver determining section 304B may determine that the request receiver is the information processing apparatus 1B of the user who satisfies a condition (e.g. a targeted person is the person who has at least a predetermined number of years of practical experience at a certain department, etc.) corresponding to that classification. As another example, in a case where the budget ceiling for the request for a survey has been decided, the request receiver determining section 304B may determine, according budget ceiling, the information processing apparatus 1B serving as the request receiver. In this case, a standard amount of reward money may be decided in advance for each information processing apparatus 1B. Further, after inquiring of each information processing apparatus 1B about the amount of reward money, the request receiver determining section 304B may determine the information processing apparatus 1B serving as the request receiver.

In S34a and S35a, negotiations conducted by the negotiating section 302B, i.e. a negotiating process, are carried out. Specifically, in S34a, the negotiating section 302B sends, to the request receiver determined in S33a, a question which the request receiver is requested to answer and a condition corresponding to the question. In S35a, the negotiating section 302B receives an answer to the question sent in S34a, from the above request receiver. The answer received here is an answer to the sent question, the answer being provided by the vicariously answering language model 4B, or an answer informing that the vicariously answering language model 4B cannot answer the sent question.

In the negotiation, the negotiating section 302B may judge whether the negotiating partner is a rightful information processing apparatus 1B. This makes it possible to prevent a reward from being fraudulently gained by answering a question in the guise of the information processing apparatus 1B. Any method can be used to judge rightfulness. For example, the negotiating section 302B may judge the rightfulness with use of identification information, or may judge the rightfulness by applying a technique such as a blockchain.

In S36a, the negotiating section 302B judges whether answers to the respective questions in the requested surveys are complete. In a case where it is judged in S36a that the answers are complete (YES in S36a), the processing continues to S37a, and in a case where it is judged in S36a that the answers are not complete (NO in S36a), the processing returns to S33a. In S33a to which a transition is made from S36a, the request receiver determining section 304B determines another request receiver.

In S37a, the reporting section 308B reports to the requester the answers obtained through the processes of S33a to S36a. The processing of the flow F3a thus ends.

Meanwhile, in S11b of the flow F1b, the accepting section 201B of the information processing apparatus 1B receives the question and the condition sent by the information processing apparatus 3B in S34a. That is, the performer of the flow F1b is the information processing apparatus 1B which is included in the plurality of information processing apparatuses 1B of the survey system 7B and which is the request receiver determined in S33a of the flow F3a.

In S12b, the authenticating section 204B judges whether the sender of the question and the condition received in S11b is rightful. In a case where the sender is judged rightful in S12b (YES in S12b), the processing continues to S13b, and in a case where the sender is judges not rightful in S12b (NO in S12b), the processing of the flow F1b end.

In S13b, the satisfaction judging section 205B judges whether the user of the information processing apparatus 1B satisfies the condition received in S11b. Note that as described above, the satisfaction judging section 205B may judge a degree to which the condition is satisfied.

In S14b, the answering allowance judging section 206B judges, on the basis of the result of the judgment made in S13b, whether to cause the vicariously answering language model 4B to generate an answer to the question. In this manner, the answering allowance judging section 206B judges whether e the vicariously answering language model 4B to generate an answer to a question which is asked the predetermined user. Further, this judgment may be made on the basis of the result of the judgment made by the satisfaction judging section 205B. In a case where it is judged in S14b that an answer should be generated (YES in S14b), the processing continues to S15b, and in a case where it is judged in S14b that an answer should not be generated (NO in S14b), the method continues to S17b. In S17b to which transition is made from S14b, the answering allowance judging section 206B sends to the information processing apparatus 3B an answer informing that answering is not allowed.

In S14b, the judgment criteria used for judging whether to generate an answer may be set as appropriate. For example, in a case where the user is judged to satisfy the condition in S13b and the amount of reward money is equal to or greater than the lower limit set by the user, the answering allowance judging section 206B may judge that an answer should be generated. Further, the presenting section 203B may present the received question, the received condition, or both to the user, to cause the user to select between allowing and disallowing answering. In this case, in a case where the user is judged to satisfy the condition in S13b and the user's selection is that answering is allowed, the answering allowance judging section 206B may judge that an answer should be generated.

In S15b, the responding section 202B uses the vicariously answering language model 4B to generate an answer to the question received in S11b. Subsequently, in S16b, the examining section 211B judges whether the answer generated in S15b is allowed to be sent in terms of the content thereof. That is, the examining section 211B judges whether a generated answer is allowed to be sent in terms of the content thereof, i.e. whether the generated answer does not have content which should not be sent. For example, a list of pieces of information which should not be sent may be stored in the storage section 11A etc. In this case, in a case where information included in the list is contained in the generated answer, the examining section 211B judges that the answer is not allowed to be sent.

In a case of YES judgment in S16b, the processing continues to S17b. In S17b, the presenting section 203B sends the answer generated in S15b to the information processing apparatus 3B. The processing of the flow F1b thus ends.

In a case of NO judgment in S16b, the processing returns to S15b, and the responding section 202B uses the vicariously answering language model 4B to generate an answer to the question received in S11b. Typically, the output from a language model stochastically varies. Therefore, inputs of the same query to the vicariously answering language model 4B can result in outputs of different answers. For this reason, in S15b to which transition is made from S16b, the responding section 202B may input queries of the same question to the vicariously answering language model 4B. Further, the responding section 202B may generate a query instructing that an answer should be generated which does not contain information that has been detected by the examining section 211B and that should not be sent, and input the query to the vicariously answering language model 4B. This makes it possible to cause the vicariously answering language model 4B to generate an answer which is more likely to be judged in S16b as eligible for sending.

As above, the language model used by the information processing apparatus 1B may be the vicariously answering language model 4B which has been trained by machine learning so as to be capable of generating, as a surrogate for a predetermined user, an answer to an inputted question. Further, the accepting section 201B accepts an input of a question asked the predetermined user. In addition, the information processing apparatus 1B includes the answering allowance judging section 206B for judging whether to cause the vicariously answering language model 4B to generate an answer to a question. This provides an example advantage of making it possible to omit, where appropriate, causing the vicariously answering language model 4B to generate an answer, in addition to the example advantage provided by the information processing apparatus 1.

As above, in a case where a predetermined user satisfies the condition associated with a question, the answering allowance judging section 206B may judge that an answer to the question should be generated by the vicariously answering language model 4B corresponding to the predetermined user. This provides an example advantage of making it possible to generate an answer fit for the condition associated with a question, in addition to the example advantage provided by the information processing apparatus 1.

As above, the information processing apparatus 3B includes the question classifying section 303B for classifying questions contained in a plurality of requests accepted by the accepting section 301B, according to the targeted persons. The negotiating section 302B then conducts negotiations on questions classified as the same classification, with a negotiating partner which corresponds to the classification. This provides an example advantage of making it possible to efficiently negotiate by compiling questions by targeted person, in addition to the example advantage provided by the information processing apparatus 3.

### (Flow of Question Answering)

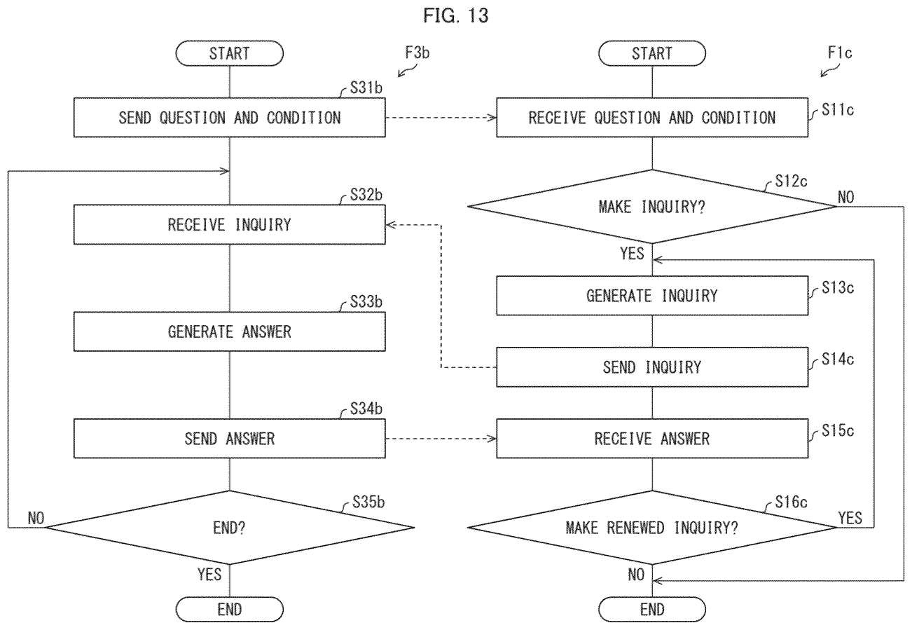

In the survey system 7B, it is also possible to conduct question answering regarding the question and the condition in the negotiations conducted between the information processing apparatuses 1B and 3B. This will be described below on the basis of FIG. 13. FIG. 13 is a diagram illustrating a flow of question answering conducted between the information processing apparatuses 1B and 3B. Illustrated in FIG. 13 are a flow F3b carried out by the information processing apparatus 3B and a flow F1c carried out by the information processing apparatus 1B.

In S31b of the flow F3b, the negotiating section 302B of the information processing apparatus 3B sends a question and a condition corresponding to the question to the information processing apparatus 1B. Note that prior to the process of S31b, the processes of S31a to S33a in FIG. 12 are carried out.

In S32b, the accepting section 301B receives an inquiry from the information processing apparatus 1B. This inquiry is an inquiry regarding at least one selected from the group consisting of the question and the condition sent in S31b, and is sent by the process of S14c, which will be described later.

In S33b, the negotiating section 302B generates an answer to an inquiry received in S32b. As an example, the negotiating section 302B may use the negotiating language model 5B to generate an answer to the inquiry received in S32b. Specifically, the negotiating section 302B inputs, to the negotiating language model 5B, the inquiry sentence (e.g. “Is an increase in the reward money possible?”, etc.) received in S32b, and generates an answer (e.g. “An increase in the reward money is impossible”, “the increase in the reward money is possible in a case where an answer to an additional question is provided”, or the like) to the inquiry, accordingly. As another example, the negotiating section 302B may notify the requester of the survey of the inquiry received. In this case, the negotiating section 302B may take, as the answer to the inquiry received in S32b, an answer to the notification from the requester of the survey.

In S34b, the negotiating section 302B sends the answer generated in S33b to the information processing apparatus 1B. In the following S35b, the negotiating section 302B judges whether to end the question answering. In a case where it is judged in S35b that the question answering should be ended (YES in S35), the processing of the flow F3b ends, and in a case where it is judged in S35b that the question answering should be continued (NO in S35b), the processing returns to S32b. The judgment criteria used for judging whether to end the question answering may be set as appropriate. For example, in a case where the reception of a renewed inquiry cannot be found within a predetermined amount of time after the sending of the answer in S34b, the negotiating section 302B may judge that the question answering should be ended.

On the other hand, in S11c of the flow F1c, the accepting section 201B of the information processing apparatus 1B receives the question and the condition sent by the information processing apparatus 3B in S31b. As in the flow F1b of FIG. 12, the authenticating section 204B may perform authentication after S11c, and whether the sender of the question and the condition is rightful may be judged, accordingly. Further, the following processes may be carried out after S13b (judgment whether the user satisfies the condition) of the flow F1b.

In S12c, the negotiating section 208B judges whether to inquire about the question and the condition received in S11c. In a case of YES judgment in S12c, the processing continues to S13c, and in a case of NO judgment in S12c, the processing of the flow F1c ends.

The judgment criteria used for judging whether to inquire in S12c may be set as appropriate. As an example, the negotiating section 208B may generate a query inquiring whether there is not an inquiry as to the question and the condition received in S11c, to input the query to the vicariously answering language model 4B, and judge, on the basis of an outputted answer, whether to inquire. As an example, in a case where the answer outputted by the vicariously answering language model 4B has content which is, for example, “both the question and the condition are clear, and there is no need for inquiry”, the negotiating section 208B may judge that an inquiry should not be made. In a case where the answer outputted by the vicariously answering language model 4B has content which is, for example, “it is recommended to inquire about the reward, which is not stipulated”, the negotiating section 208B may judge that an inquiry should be made.

As another example, in a case where the amount of reward money is smaller than a predetermined threshold or in a case where the user does not satisfy some of the conditions, the negotiating section 208B may judge that an inquiry should be made. As still another example, the presenting section 203B may present to a user the received question and condition, to cause the user to select between making and not making an inquiry. In this case, when the selection of the user is to make an inquiry, the negotiating section 208B judges that an inquiry should be made.

In S13c, the negotiating section 208B generates an inquiry. In S14c, the negotiating section 208B sends the generated inquiry to the information processing apparatus 3B. A method for generating the inquiry may be determined in advance. As an example, the negotiating section 208B may cause the vicariously answering language model 4B to generate the inquiry. In this case, the negotiating section 208B may generate a query instructing that an inquiry should be generated about the question and the condition received in S11c, to input the query to the vicariously answering language model 4B. As another example, fixed inquiry sentences such as “tell me more detailed information regarding the condition” and “is an increase in reward money possible?” may be prepared in advance. In this case, the negotiating section 208B may select the inquiry sentence in accordance with the question and the condition received in S11c.

In S15c, the negotiating section 208B receives the answer sent by the information processing apparatus 3B in S34b. Subsequently, in S16c, the negotiating section 208B judges whether to make a renewed inquiry as to the answer received in S15c. As in S12c, the judgment criteria used for judging whether to make a renewed inquiry may be set as appropriate. In a case of YES judgment in S16c, the processing returns to S13c, and in a case of NO judgment in S16c, the processing of the flow F1c ends. After the end of the processing of the flow F1c, the processing may continue to, for example, the process of S14b of the flow F1b of FIG. 12.

### (Calculation of Reliability, Generation of Alternative Condition, Acceptance of Modification Made by User)

The reliability judging section 209B of the information processing apparatus 1B judges the reliability of the answer generated by the vicariously answering language model 4B. The reliability is an index which indicates the reliability of an answer. Further, the alternative condition generating section 207B generates an alternative condition which replaces the condition associated with a question the answer to which is sought. Furthermore, the modifying section 210B accept a modification made by a user to the answer generated by the vicariously answering language model 4B. These processes will be described below on the basis of FIG. 14. FIG. 14 is a flowchart illustrating example processes carried out by the information processing apparatus 1B.

In S11d of a flow F1d illustrated in FIG. 14, the accepting section 201B receives the question and the condition sent by the information processing apparatus 3B. As in the flow F1b of FIG. 12, the authenticating section 204B may perform authentication after S11d, and whether the sender of the question and the condition is rightful may be judged, accordingly. Further, the following processes may be carried out after S13b (judgment whether the user satisfies the condition) of the flow F1b.

In S12d, the answering allowance judging section 206B judges whether to cause the vicariously answering language model 4B to generate an answer to the question. In a case of YES judgment in S12d, the processing continues to S13d, and in a case of NO judgment in S12d, the processing continues to S18d.

In S13d, the responding section 202B uses the vicariously answering language model 4B to generate an answer to the question received in S11d. Subsequently, in S14d, the reliability judging section 209B judges the reliability of the answer generated in S13d.

A method for judging the reliability is not particularly limited. For example, in a case where an answer generated with use of the vicariously answering language model 4B of one user contains the job-related data concerning the one user and in a case where the answer agrees with an answer having been inputted by the one user in the past, the reliability judging section 209B may judge that the reliability of the answer is high. In a case where the answer does not contain the job-related data concerning the one user and in a case where there is an inconsistency between the answer and an answer having been inputted by the one user in the past, the reliability judging section 209B may judge that the reliability of the answer is low. Note that the reliability judging section 209B may judge which of a plurality of levels such as high, middle, and low levels the reliability falls under, or may calculate a numerical value indicating the reliability.

In S15d, the presenting section 203B presents to the user the answer generated in S13d. In this presentation, the presenting section 203B may also present to the user the reliability judged in S14d.

In S16d, the modifying section 210B accepts a modification made by the user to the answer presented in S15d. Then, as to an answer to which a modification has been made by the user and as to an answer the content of which has been validated by the user and to which no modification has been made, the reliability judging section 209B may update the reliabilities of such answers. For example, the reliability judging section 209B may update the reliabilities of such answers so as to increase the reliabilities by one level or a predetermined value, or may update the reliabilities of the answers with the maximum reliability value.

In S17d, the presenting section 203B sends to the information processing apparatus 3B the answer generated in S13d or the answer modified in S16d. The processing of the flow F1d thus ends. Note that in S17d, the presenting section 203B may notify the information processing apparatus 3B of the reliability of the answer. Further, with the processes of S15d and S16d omitted, in S17d, the presenting section 203B may omit sending an answer having a reliability, judged in S14d, which is smaller than a threshold, or may send an answer indicating that answering the question is not allowed.

As described above, in a case of NO judgment in S12d, the processing continues to S18d. In S18d, the alternative condition generating section 207B generates an alternative condition which replaces the condition received in S11d.

A method for generating the alternative condition may be determined in advance. As an example, the alternative condition generating section 207B may cause the vicariously answering language model 4B to generate the alternative condition. In this case, the alternative condition generating section 207B may generate a query instructing that regarding the question and the condition received in S11d, an alternative condition be generated, to input the query to the vicariously answering language model 4B. As another example, regarding a question an answer to which does not necessarily need to be checked by a user, an alternative condition generation rule such as requiring a 10% increase in presented reward money instead of having the answer checked by the user may be set in advance. In this case, the alternative condition generating section 207B can generate an alternative condition according to the set generation rule.

In S19d, the presenting section 203B presents to the user the alternative condition generated in S18d. Subsequently, in S20d, the alternative condition generating section 207B accepts a modification made by the user to the alternative condition. Note that in S18d, an alternative condition may be inputted by the user. In this case, the processes of S19d and S20d are omitted.

In S21d, the negotiating section 208B notifies the information processing apparatus 3B of an alternative condition generated in S18d or the alternative condition to which a modification is made in S20d, and inquires of the information processing apparatus 3B whether to approve of the alternative condition. Upon the reception of the alternative condition by the information processing apparatus 3B, the negotiating section 302B judges whether to approve of the alternative condition and notifies the information processing apparatus 1B of the result of the judgment.

A method for judging whether to approve of the alternative condition may be determined in advance. As an example, the negotiating section 302B may generate a query inquiring whether to approve of the received alternative condition and input the query to the negotiating language model 5B to obtain an answer to the query, and judges, on the basis of the answer, whether to approve of the alternative condition. As another example, an acceptable range of a condition such as a reward may be determined in advance. In this case, when the alternative condition is within the acceptable range, the negotiating section 302B may judge the alternative condition as approving, and when the alternative condition is beyond the acceptable range, the negotiating section 302B may judge the alternative condition as disapproving. Further, the negotiating section 302B may present the alternative condition to the requester of the survey, to cause the requester to select between approving and disapproving of the alternative condition.

In S22d, the negotiating section 208B judges whether the alternative condition is approved of. In a case of YES judgment in S22d, the processing continues to S13d, and in a case of NO judgment in S22d, the processing of the flow F1d ends. Note that in the case of NO judgment in S22d, the processing may return to S18d so that another alternative condition is generated.

As above, the information processing apparatus 1B includes: an alternative condition generating section 207B for generating an alternative condition which replaces a condition associated with a question; and a negotiating section 208B for notifying the sender of the question of the alternative condition to inquire of the sender whether to approve of the alternative condition. This provides an example advantage of making it possible to flexibly negotiate by making changes to a condition, in addition to the example advantage provided by the information processing apparatus 1.

As described above, the information processing apparatus 1B may include the designating section 101 or 101A and the adjusting section 102. In this case, the designating section 101 or 101A may designate, as the job-related data, a combination of the answer modified in S16d and the question corresponding to the answer. The adjusting section 102 may then use the job-related data as training data, to retrain the vicariously answering language model 4B. Further, instead of the retraining, the adjusting section 102 may register the job-related data as data to be referred to in generating an answer via the vicariously answering language model 4B. This make it possible to improve the accuracy of an answer obtained with use of the vicariously answering language model 4B.

### (Generation of Alternative Condition Performed on Information Processing Apparatus 3B-Side)

An alternative condition can be generated on the information processing apparatus 3B-side. The generation of an alternative condition by the information processing apparatus 3B will be described below on the basis of FIG. 15. FIG. 15 is a flowchart illustrating a flow of example processes carried out by the information processing apparatus 3B.

In S31c of a flow F3c illustrated in FIG. 15, the negotiating section 302B receives, from the information processing apparatus 1B, an answer informing that answering a question is not allowed. This answer is the answer sent in S17a of the flow F1b of FIG. 12 in a case of NO judgment in S14a.

In S32c, the alternative condition generating section 305B generates an alternative condition which replaces the condition previously notified to the information processing apparatus 1B. A method for generating the alternative condition may be determined in advance. As an example, the alternative condition generating section 305B may cause the negotiating language model 5B to generate the alternative condition. In this case, the alternative condition generating section 305B may generate a query instructing that an alternative condition should be generated regarding the question and the condition previously sent, to input the query to the negotiating language model 5B. As another example, in a case where approval is not obtained as to answering a question which does not necessarily need to be checked by a user, an alternative condition generation rule may be set in advance such as having an answer checked by a user instead of a 5% increase in reward. In this case, the alternative condition generating section 305B can generate an alternative condition according to the set generation rule. Note that the alternative condition generating section 305B may notify the requester of the survey of the generated alternative condition, to inquire of the requester whether to approve of the alternative condition. Further, a condition range (e.g. the range of the amount of reward money) acceptable to the requester may be determined in advance. In this case, the alternative condition generating section 305B generates an alternative condition within the stipulated range. Furthermore, the alternative condition generating section 305B may notify the requester of the fact that answering a question has not been approved of, and ask the requester to set an alternative condition.

In S33c, the negotiating section 302B sends the alternative condition generated in S32c, to the information processing apparatus 1B which is the negotiating partner to inquire whether to approve of the alternative condition. When the information processing apparatus 1B receives the alternative condition, the negotiating section 208B judges whether to approve of the alternative condition and notifies the information processing apparatus 3B of the result of the judgment.

A method for judging whether to approve of the alternative condition may be determined in advance. As an example, the negotiating section 208B may generate a query inquiring whether to approve of the received alternative condition and input the query to the vicariously answering language model 4B, to obtain an answer to the query, and judges, on the basis of the answer, whether to approve of the alternative condition. As another example, an acceptable range of a condition such as a reward may be determined in advance. In this case, when the alternative condition is within the acceptable range, the negotiating section 208B may judge the alternative condition as approving, and when the alternative condition is beyond the acceptable range, the negotiating section 208B may judge the alternative condition as disapproving. Further, the negotiating section 208B may present the alternative condition to the user of the information processing apparatus 1B, to cause the user to select between approving and disapproving of the alternative condition.

In S34c, the negotiating section 302B judges whether the alternative condition is approved of. In a case of YES judgment in S34c, the processing continues to S35c, and in a case of NO judgment in S34c, the processing of the flow F3c ends. Note that in the case of NO judgment in S34c, the negotiating section 302B may return to S32c to generate another alternative condition. Alternatively, in the case of NO judgment in S34c, the negotiating section 302B may ask the information processing apparatus 1B which is the negotiating partner to present an alternative condition. In this case, the process of the S18d and the subsequent processes of FIG. 14 are carried out in the information processing apparatus 1B which is the negotiating partner.

In S35c, the negotiating section 302B requests the information processing apparatus 1B which is the negotiating partner to answer the question. The processing of the flow F3c thus ends. Thereafter, the process of S35a and the subsequent processes of the flow F3a of FIG. 12 are carried out.

As above, the information processing apparatus 3B includes an alternative condition generating section 305B for generating an alternative condition as to an answer to a question in a case where a negotiating partner does not approve of answering the question. The negotiating section 302B then notifies the negotiating partner of the alternative condition, to inquire of the negotiating partner whether to approve of the alternative condition. This provides an example advantage of making it possible to flexibly negotiate by making changed to a condition, in addition to the example advantage provided by the information processing apparatus 3.

### (Acceptance of Addition of Question)

The question adding section 307B of the information processing apparatus 3B accepts an additional question from the requester of the survey, regarding an answer generated by the information processing apparatus 1B via the vicariously answering language model 4B. The acceptance of an additional question will be described below on the basis of FIG. 16. FIG. 16 is a flowchart illustrating example processes in which the information processing apparatus 3B accepts an additional question.

In S31d of a flow F3d illustrated in FIG. 16, the negotiating section 302B receives an answer to a question from the information processing apparatus 1B. In this reception, the negotiating section 302B may receive, from the information processing apparatus 1B, not only the answer but also the reliability of the answer. The reliability is the reliability judged in S14d of FIG. 15. Note that prior to the process of S31d, the processes of S31a to S34a of the flow F3a of FIG. 12 are carried out.

In S32d, the question adding section 307B notifies the requester of the answer received in S32d. In this notification, the negotiating section 302B may also notify the reliability of the answer. Further, in S32d, the question adding section 307B may send to the requester a message prompting the requester to send an additional question regarding the answer notified of. Note that in a case where the condition associated with the question stipulates whether an additional question is allowed to be asked or the number of times an additional question is accepted, the question adding section 307B sends a message in accordance with the stipulation. For example, in a case where the number of times an additional question is accepted is stipulated, the question adding section 307B may also contain such a number of times in the above message. Further, in a case where the condition stipulates that an additional question is not accepted, the question adding section 307B may contain such stipulation in the above message. In this case, the processing of the flow F3d ends upon NO judgment in S33d, which will be described below.

In S33d, the question adding section 307B judges whether an additional question is received from the requester. In a case of NO judgment in S33d, the processing of the flow F3d ends. After the ends of the processing of the flow F3d, the process of S36a and the subsequent processes of the flow F3a of FIG. 12 are carried out.

In S34d, the question adding section 307B sends to the information processing apparatus 1B the additional question received from the requester, to cause the vicariously answering language model 4B to generate an answer to the additional question. Thereafter, the processing returns to S31d, and the negotiating section 302B receives the answer to the additional question.

As above, the information processing apparatus 3B includes a question adding section 307B for accepting an additional question from the requester of the survey regarding the answer generated by the vicariously answering language model 4B and causing the vicariously answering language model 4B to generate an answer to the additional question. This provides an example advantage of making it possible for the requester to clarify an uncertainty about an answer and ask an additional question which is a more in-depth question, in addition to the example advantage provided by the information processing apparatus 3.

### (Evaluation of Answer and Renegotiation)

The answer evaluating section 306B of the information processing apparatus 3B evaluates the answer generated by the information processing apparatus 1B via the vicariously answering language 4B. The negotiating section 302B then conducts renegotiations on the condition, in accordance with the result of the evaluation made by the answer evaluating section 306B. The evaluation of an answer and renegotiation will be described below on the basis of FIG. 17. FIG. 17 is a flowchart illustrating example processes in which the information processing apparatus 3B evaluates an answer and renegotiates.

In S31e of a flow F3e illustrated in FIG. 17, the negotiating section 302B receives an answer to a question from the information processing apparatus 1B. Note that prior to the process of S31e, the processes of S31a to S34a of the flow F3a of FIG. 12 are carried out.

In S32e, the answer evaluating section 306B evaluates the answer received in S31e. A method for evaluating the answer may be determined in advance. For example, the answer evaluating section 306B may evaluate the answer on the basis of whether the received answer satisfies the condition associated with the question. As a specific example, in a case where although the condition stipulates that each answer is checked by a user and is modified when needed, the fact that the user has performed a check is not indicated in the received answer, the answer evaluating section 306B gives the answer a low evaluation. The evaluation may be conducted by judging which of a plurality of levels such as high, middle, and low levels applies. Further, the answer evaluating section 306B may calculate an index value which indicates whether an answer is good or bad. Furthermore, the answer evaluating section 306B may evaluate an answer on the basis of the reliability notified of by the information processing apparatus 1B. For example, the answer evaluating section 306B may take the average of the reliabilities of respective answers as the evaluation value of the answers.

In S33e, the negotiating section 302B judges, on the basis of the result of the evaluation made in S32e, whether to negotiate on a reward. For example, when the result of the evaluation made in S32e is within a predetermined acceptable range, the negotiating section 302B may judge that negotiations should not be conducted, and when the result of the evaluation made in S32e is outside the acceptable range, the negotiating section 302B may judge that negotiations should be conducted. Note that it is possible for the negotiating section 302B to negotiate on a condition other than a reward (e.g. whether an additional question is allowed to be asked and an allowable number of times an additional question is asked, whether it is necessary for a user to check and modify an answer, etc.). In a case of YES judgment in S33e, the processing continues to S34e, and renegotiations on the condition as to the answer to the question are conducted. In a case of NO judgment in S33e, the processing continues to S37e without renegotiation.

In S34e, the negotiating section 302B causes the alternative condition generating section 305B to set again the amount of reward money. A method for setting again the amount of reward money may be determined in advance. As an example, the alternative condition generating section 305B may set again the amount of reward money within a predetermined standard amount of reward money. As another example, the alternative condition generating section 305B may cause the negotiating language model 5B to set again the amount of reward money. In this case, the alternative condition generating section 305B may generate a query instructing that the amount of reward money should be set again in the light of the question and condition previously sent and the result of the evaluation made in S32e, to input the query to the negotiating language model 5B. As another example, the relationship between the result of the evaluation made in S32e and the reward reduction rate may be modeled. In this case, the alternative condition generating section 305B can set again the amount of reward money with use of the model. As still another example, the alternative condition generating section 305B may set again the amount of reward money in consideration of an answer history and reliabilities of the past of the information processing apparatus 1B.

In S35e, the negotiating section 302B notifies the information processing apparatus 1B of the amount 4 reward money set again in S34e. When the information processing apparatus 1B receives the notification of the amount of reward money, the negotiating section 208B judges whether to approve of the amount of reward money, and notifies the information processing apparatus 3B of the result of the judgment.

A method for judging whether to approve of the amount of reward money may be determined in advance. As an example, the negotiating section 208B may generate a query inquiring whether to approve of the amount of reward money notified of and input the query to the vicariously answering language model 4B to obtain an answer to the query, and judges, on the basis of the answer, whether to approve of the amount of reward money. As another example, an acceptable range of a condition such as a reward may be determined in advance. In this case, when the amount of reward money notified of is within the acceptable range, the negotiating section 208B may judge the amount of reward money as approving, and when the amount of reward money notified of is beyond the acceptable range, the negotiating section 208B may judge the amount of reward money as disapproving. Further, the negotiating section 208B may present the amount of reward money notified of to the user of the information processing apparatus 1B, to cause the user to select between approving and disapproving of the amount of reward money.

In S36e, the negotiating section 302B judges whether the amount of reward money set again is approved of. In a case of NO judgment in S36e, the processing returns to S33e, and in a case of YES judgment in S36e, the processing continues to S37e. In S37e, the negotiating section 302B notifies the requester of the amount of reward money determined, and the processing of the flow F3e thus ends. Thereafter, the requester provides the user of the information processing apparatus 1B with the determined amount of reward money.

As above, the information processing apparatus 3B includes an answer evaluating section 306B for evaluating an answer generated by the vicariously answering language model 4B, and the negotiating section 302B renegotiates, based on the evaluating, on the condition as to the answer to a question. This provides an example advantage of making it possible to automatically review a condition depending on whether a generated answer is good or bad, in addition to the example advantage provided by the information processing apparatus 3.

### [Variation]

A performer which carries out each of the processes described in the example embodiments above is any performer, and is not limited to the above examples. In other words, it is possible to implement the functions of the information processing apparatuses 1, 1A, 1B, 2, 3, and 3B with use of a plurality of apparatuses (which can be said to be processors) capable of communicating with each other. For example, the respective processes described in the flowcharts of FIGS. 2, 4, 7, 8, and 12 to 17 can be shared and carried out by the plurality of processors. That is, the performer of the processes in the example embodiments described above may be a single processor, or may be a plurality of processors.

### [Software Implementation Example]

Some or all of the functions of each of the information processing apparatuses 1, 1A, 1B, 2, 3, and 3B (hereinafter also referred to as “each apparatus above”) may be implemented by hardware such as an integrated circuit (IC chip), or may be implemented by software.

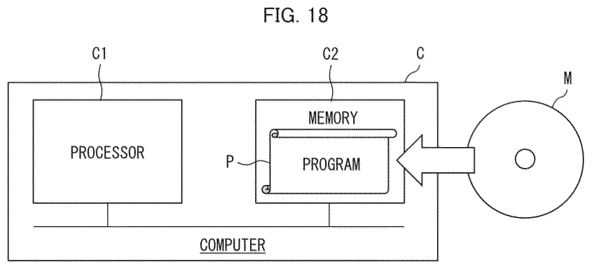

In the latter case, each apparatus above is provided by, example, a computer that executes instructions of a program that is software implementing the foregoing functions. An example (hereinafter, computer C) of such a computer is illustrated in FIG. 18. FIG. 18 is a block diagram illustrating a configuration of the computer C which functions as each apparatus above.

The computer C includes at least one processor C1 and at least one memory C2. The memory C2 has recorded thereon a program (adjustment program/response program/intermediary program) P for causing the computer C to operate as each apparatus above. The processor C1 of the computer C retrieves the program P from the memory C2 and executes the program P, so that the functions of each apparatus above are implemented.

Examples of the at least one processor C1 can include a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, and a combination thereof. Examples of the memory C2 can include a flash memory, a hard disk drive (HDD), a solid state drive (SSD), and a combination thereof.

The computer C may further include a random access memory (RAM) into which the program P is loaded at the time of execution and in which various kinds of data are temporarily stored. The computer C may further include a communication interface via which data is transmitted to and received from another apparatus. The computer C may further include an input-output interface via which input-output equipment such as a keyboard, a mouse, a display or a printer is connected.

The program P can be recorded on a non-transitory tangible recording medium M capable of being read by the computer C. Examples of such a recording medium M can include a tape, a disk, a card, a semiconductor memory, and a programmable logic circuit. The computer C can obtain the program P via such a recording medium M. The program P can be transmitted via a transmission medium. Examples of such a transmission medium can include a communication network and a broadcast wave. The computer C can also obtain the program P via such a transmission medium.

### [Additional Remark 1]

The whole or part of the example embodiments disclosed above can be described as, but not limited to, the following supplementary notes.

### (Supplementary Note A1)

An information processing apparatus, including: an accepting means for accepting a request for a survey in which answers to a predetermined question are collected; and a negotiating means for conducting, with a predetermined negotiating partner, negotiations for causing a vicariously answering language model to generate an answer to the predetermined question, the vicariously answering language model having been trained by machine learning so as to be capable of generating, as a surrogate for a predetermined user, an answer to an inputted question.

### (Supplementary Note A2)

The information processing apparatus described in supplementary note A1, in which the negotiating means is configured to provide the predetermined negotiating partner with a notification of a condition as to an answer to the predetermined question, the condition being associated with the predetermined question, and determine, based on an answer to the notification received from the predetermined negotiating partner, whether to ask the predetermined negotiating partner for an answer to the predetermined question.

### (Supplementary Note A3)

The information processing apparatus described in supplementary note A2, in which the condition includes at least one selected from the group consisting of a reward for providing the answer, an answering method, whether an additional question is permitted, an attribute of a respondent, and a scope of information to be contained in the answer.

### (Supplementary Note A4)

The information processing apparatus described in any one of supplementary notes A1 to A3, further including an alternative condition generating means for generating an alternative condition as to an answer to the predetermined question in a case where the predetermined negotiating partner does not approve of answering to the predetermined question, the negotiating means being configured to notify the predetermined negotiating partner of the alternative condition, and inquire of the predetermined negotiating partner whether to approve of the alternative condition.

### (Supplementary Note A5)

The information processing apparatus described in any one of supplementary notes A1 to A4, further including an answer evaluating means for evaluating an answer generated by the vicariously answering language model, the negotiating means being configured to renegotiate, based on a result of the evaluating, on a condition as to an answer to the predetermined question.

### (Supplementary Note A6)

The information processing apparatus described in any one of supplementary notes A1 to A5, further including a question adding means for accepting, from a requester of the survey, an additional question regarding an answer generated vicariously answering language model and causing the vicariously answering language model to generate an answer to the additional question.

### (Supplementary Note A7)

The information processing apparatus described in any one of supplementary notes A1 to A6, in which the negotiating means is configured to conduct the negotiations with use of a negotiating language model generated by machine learning in which used as training data is a negotiation history represented in a natural language.

### (Supplementary Note A8)

The information processing apparatus described in any one of supplementary notes A1 to A7, further including a question classifying means for classifying questions contained in a plurality of requests accepted by the accepting means, according to targeted persons of the questions, the negotiating means being configured to conduct negotiations on questions classified as the same classification, with the predetermined negotiating partner which corresponds to the classification.

### (Supplementary Note B1)

An intermediary method, including: at least one processor accepting a request for a survey in which answers to a predetermined question are collected; and the at least one processor conducting, with a predetermined negotiating partner, negotiations for causing a vicariously answering language model to generate an answer to the predetermined question, the vicariously answering language model having been trained by machine learning so as to be capable of generating, as a surrogate for a predetermined user, an answer to an inputted question.

### (Supplementary Note B2)

The intermediary method described in supplementary note B1, in which in the conducting negotiations, the at least one processor provides the predetermined negotiating partner with a notification of a condition as to an answer to the predetermined question, the condition being associated with the predetermined question, and determines, based on an answer to the notification received from the predetermined negotiating partner, whether to ask the predetermined negotiating partner for an answer to the predetermined question.

### (Supplementary Note B3)

The intermediary method described in supplementary note B2, in which the condition includes at least one selected from the group consisting of a reward for providing the answer, an answering method, whether an additional question is permitted, an attribute of a respondent, and a scope of information to be contained in the answer.

### (Supplementary Note B4)

The intermediary method described in any one of supplementary notes B1 to B3, further including the at least one processor generating an alternative condition as to an answer to the predetermined question in a case where the predetermined negotiating partner does not approve of answering to the predetermined question, wherein in the conducting negotiations, the at least one processor notifies the predetermined negotiating partner of the alternative condition, and inquires of the predetermined negotiating partner whether to approve of the alternative condition.

### (Supplementary Note B5)

The intermediary method described in any one of supplementary notes B1 to B4, further including the at least one processor evaluating an answer generated by the vicariously answering language model, wherein the at least one processor renegotiates, based on a result of the evaluating, on a condition as to an answer to the predetermined question.

### (Supplementary Note B6)

The intermediary method described in supplementary notes B1 to B5, further including the at least one processor accepting, from a requester of the survey, an additional question regarding an answer generated by the vicariously answering language model and causing the vicariously answering language model to generate an answer to the additional question.

### (Supplementary Note B7)

The intermediary method described in any one of supplementary notes B1 to B6, in which in the conducting negotiations, the at least one processor conducts the negotiations with use of a negotiating language model generated by machine learning in which used as training data is a negotiation history represented in a natural language.

### (Supplementary Note B8)

The intermediary method described in any one of supplementary notes B1 to B7, further including the at least one processor classifying questions contained in a plurality of requests accepted in the accepting, according to targeted persons of the questions, wherein in the conducting negotiations, the at least one processor conducts negotiations on questions classified as the same classification, with the predetermined negotiating partner which corresponds to the classification.

### (Supplementary Note C1)

An intermediary program for causing a computer to function as: an accepting means for accepting a request for a survey in which answers to a predetermined question are collected; and a negotiating means for conducting, with a predetermined negotiating partner, negotiations for causing a vicariously answering language model to generate an answer to the predetermined question, the vicariously answering language model having been trained by machine learning so as to be capable of generating, as a surrogate for a predetermined user, an answer to an inputted question.

### (Supplementary Note C2)

The intermediary program described in supplementary note C1, in which the negotiating means is configured to provide the predetermined negotiating partner with a notification of a condition as to an answer to the predetermined question, the condition being associated with the predetermined question, and determine, based on an answer to the notification received from the predetermined negotiating partner, whether to ask the predetermined negotiating partner for an answer to the predetermined question.

### (Supplementary Note C3)

The intermediary program described in supplementary note C2, in which the condition includes at least one selected from the group consisting of a reward for providing the answer, an answering method, whether an additional question is permitted, an attribute of a respondent, and a scope of information to be contained in the answer.

### (Supplementary Note C4)

The intermediary program described in any one of supplementary notes C1 to C3, further causing the computer to function as an alternative condition generating means for generating an alternative condition as to an answer to the predetermined question in a case where the predetermined negotiating partner does not approve of answering to the predetermined question, the negotiating means being configured to notify the predetermined negotiating partner of the alternative condition, and inquire of the predetermined negotiating partner whether to approve of the alternative condition.

### (Supplementary Note C5)

The intermediary program described in any one of supplementary notes C1 to C4, further causing the computer to function as an answer evaluating means for evaluating an answer generated by the vicariously answering language model, the negotiating means being configured to renegotiate, based on a result of the evaluating, on a condition as to an answer to the predetermined question.

### (Supplementary Note C6)

The intermediary program described in any one of supplementary notes C1 to C5, further causing the computer to function as a question adding means for accepting, from a requester of the survey, an additional question regarding an answer generated by the vicariously answering language model and causing the vicariously answering language model to generate an answer to the additional question.

### (Supplementary Note C7)

The intermediary program described in any one of supplementary notes C1 to C6, in which the negotiating means is configured to conduct the negotiations with use of a negotiating language model generated by machine learning in which used as training data is a negotiation history represented in a natural language.

### (Supplementary Note C8)

The intermediary program described in any one of supplementary notes C1 to C7, further causing the computer to function as a question classifying means for classifying questions contained in a plurality of requests accepted by the accepting means, according to targeted persons of the questions, the negotiating means being configured to conduct negotiations on questions classified as the same classification, with the predetermined negotiating partner which corresponds to the classification.

### [Additional Remark 2]

The whole or part of the example embodiments disclosed above can be described as, but not limited to, the following supplementary notes.

### (Supplementary Note D1)

An information processing apparatus, including at least one processor, the at least one processor carrying out: an accepting process of accepting a request for a survey in which answers to a predetermined question are collected; and a negotiating process of conducting, with a predetermined negotiating partner, negotiations for causing a vicariously answering language model to generate an answer to the predetermined question, the vicariously answering language model having been trained by machine learning so as to be capable of generating, as a surrogate for a predetermined user, an answer to an inputted question.

### (Supplementary Note D2)

The information processing apparatus described in supplementary note D1, in which in the negotiating process, the at least one processor provides the predetermined negotiating partner with a notification of a condition as to an answer to the predetermined question, the condition being associated with the predetermined question, and determines, based on an answer to the notification received from the predetermined negotiating partner, whether to ask the predetermined negotiating partner for an answer to the predetermined question.

### (Supplementary Note D3)

The information processing apparatus described in supplementary note D2, in which the condition includes at least one selected from the group consisting of a reward for providing the answer, an answering method, whether an additional question is permitted, an attribute of a respondent, and a scope of information to be contained in the answer.

### (Supplementary Note D4)

The information processing apparatus described in any one of supplementary notes D1 to D3, in which in a case where the predetermined negotiating partner does not approve of answering to the predetermined question, the at least one processor further carries out an alternative condition generating process of generating an alternative condition as to an answer to the predetermined question, and in the negotiating process, the at least one processor notifies the predetermined negotiating partner of the alternative condition, and inquires of the predetermined negotiating partner whether to approve of the alternative condition.

### (Supplementary Note D5)

The information processing apparatus described in any one of supplementary notes D1 to D4, in which the at least one processor further carries out an answer evaluating process of evaluating an answer generated by the vicariously answering language model, and in the negotiating process, the at least one processor renegotiates, based on a result of the evaluating, on a condition as to an answer to the predetermined question.

### (Supplementary Note D6)

The information processing apparatus described in any one of supplementary notes D1 to D5, in which the at least one processor further carries out a question adding process of accepting, from a requester of the survey, an additional question regarding an answer generated by the vicariously answering language model and causing the vicariously answering language model to generate an answer to the additional question.

### (Supplementary Note D7)

The information processing apparatus described in any one of supplementary notes D1 to D6, in which in the negotiating process, the at least one processor conducts the negotiations with use of a negotiating language model generated by machine learning in which used as training data is a negotiation history represented in a natural language.

### (Supplementary Note D8)

The information processing apparatus described in any one of supplementary notes D1 to D7, in which the at least one processor further carries out a question classifying process of classifying questions contained in a plurality of requests accepted in the accepting process, according to targeted persons of the questions, and in the negotiating process, the at least one processor conducts negotiations on questions classified as the same classification, with the predetermined negotiating partner which corresponds to the classification.

The information processing apparatus may further include a memory. The memory may have stored therein a program for causing the at least one processor to carry out the each of the processes.

### (Supplementary Note E1)

A non-transitory recording medium having recorded thereon an intermediary program for causing a computer to function as an information processing apparatus, the intermediary program causing the computer to carry out: an accepting process of accepting a request for a survey in which answers to a predetermined question are collected; and a negotiating process of conducting, with a predetermined negotiating partner, negotiations for causing a vicariously answering language model to generate an answer to the predetermined question, the vicariously answering language model having been trained by machine learning so as to be capable of generating, as a surrogate for a predetermined user, an answer to an inputted question.

### REFERENCE SIGNS LIST

3: Information processing apparatus
301: Accepting section (accepting means)
302: Negotiating section (negotiating means)
3B: Information processing apparatus
301B: Accepting section (accepting means)
302B: Negotiating section (negotiating means)
303B: Question classifying section (question classifying means)
305B: Alternative condition generating section (alternative condition generating means)
306B: Answer evaluating section (answer evaluating means)
307B: Question adding section (question adding means)
4B: Vicariously answering language model
5B: Negotiating language model

1. An information processing apparatus, comprising at least one processor, the at least one processor carrying out:
an accepting process of accepting a request for a survey in which answers to a predetermined question are collected; and
a negotiating process of conducting, with a predetermined negotiating partner, negotiations for causing a vicariously answering language model to generate an answer to the predetermined question, the vicariously answering language model having been trained by machine learning so as to be capable of generating, as a surrogate for a predetermined user, an answer to an inputted question.

2. The information processing apparatus according to claim 1, wherein in the negotiating process, the at least one processor provides the predetermined negotiating partner with a notification of a condition as to an answer to the predetermined question, the condition being associated with the predetermined question, and determines, based on an answer to the notification received from the predetermined negotiating partner, whether to ask the predetermined negotiating partner for an answer to the predetermined question.

3. The information processing apparatus according to claim 2, wherein the condition includes at least one from the group consisting of a reward for providing the answer, an answering method, whether an additional question is permitted, an attribute of a respondent, and a scope of information to be contained in the answer.

4. The information processing apparatus according to claim 1, wherein
in a case where the predetermined negotiating partner does not approve of answering to the predetermined question, the at least processor further carries out an alternative condition generating process of generating an alternative condition as to an answer to the predetermined question, and
in the negotiating process, the at least one processor notifies the predetermined negotiating partner of the alternative condition, and inquires of the predetermined negotiating partner whether to approve of the alternative condition.

5. The information processing apparatus according to claim 1, wherein the at least one processor further carries out
an answer evaluating process of evaluating an answer generated by the vicariously answering language model, and
in the negotiating process, the at least one processor renegotiates, based on a result of the evaluating, on a condition as to an answer to the predetermined question.

6. The information processing apparatus according to claim 1, wherein the at least one processor further carries out
a question adding process of accepting, from a requester of the survey, an additional question regarding an answer generated by the vicariously answering language model and causing the vicariously answering language model to generate an answer to the additional question.

7. The information processing apparatus according to claim 1, wherein in the negotiating process, the at least one processor conducts the negotiations with use of a negotiating language model generated by machine learning in which used as training data is a negotiation history represented in a natural language.

8. The information processing apparatus according to claim 1, wherein the at least one processor further carries out
a question classifying process of classifying questions contained in a plurality of requests accepted in the accepting process, according to targeted persons of the questions, and
in the negotiating process, the at least one processor conducts negotiations on questions classified as the same classification, with the predetermined negotiating partner which corresponds to the classification.

9. An intermediary method, comprising:
at least one processor accepting a request for a survey in which answers to a predetermined question are collected; and
the at least one processor conducting, with a predetermined negotiating partner, negotiations for causing a vicariously answering language model to generate an answer to the predetermined question, the vicariously answering language model having been trained by machine learning so as to be capable of generating, as a surrogate for a predetermined user, an answer to an inputted question.

10. A non-transitory recording medium having recorded thereon an intermediary program for causing a computer to carry out:
an accepting process of accepting a request for a survey in which answers to a predetermined question are collected; and
a negotiating process of conducting, with a predetermined negotiating partner, negotiations for causing a vicariously answering language model to generate an answer to the predetermined question, the vicariously answering language model having been trained by machine learning so as to be capable of generating, as a surrogate for a predetermined user, an answer to an inputted question.
